(19) United States
(12) Patent Application Publication
(10) Pub. No.: US 2011/0263423 A1
(43) Pub. Date: Oct. 27, 2011

(54) Plant Health Composition

(75) Inventors: Ronald Wilhelm, Hofheim (DE); Michael Merk, Arese (IT); Robert John Gladwin, Macclesfield (GB); Lutz Brahm, Worms (DE); Marco-Antonio Tavares-Rodrigues, Sao Paulo (BR); Alexander Guttenkunst Prade, Sao Paulo (BR); Dirk Voesta, Limburgerhof (DE)

(73) Assignee: BASF SE, Ludwigshafen (DE)

(21) Appl. No.: 12/865,784

(22) PCT Filed: Feb. 4, 2009
(86) PCT No.: PCT/EP2009/051241

§ 371 Date: Nov. 30, 2010

(30) Foreign Application Priority Data
Feb. 5, 2008 (EP) PCT/EP2008/051375
Aug. 1, 2008 (EP) 08161625.2

(51) Int. Cl. A01N 43/56; A01N 43/653; A01P 21/00; A01P 7/04; A01P 13/00; C05F 11/00; A01P 3/00

(52) U.S. Cl. 504/101; 71/27; 514/383

(57) ABSTRACT

The present invention relates to a method for improving the plant health of at least one plant variety, which method comprises treating the plant and/or the locus where the plant is growing or is intended to grow with an amide compound of the formula I (compound I). The present invention also relates to a method for improving the plant health of at least one plant variety, which method comprises treating the plant and/or the locus where the plant is growing or is intended to grow with a mixture comprising an amide compound having the formula I (compound I) and at least one compound selected from the group consisting of a further fungicide II (compound II), a further fungicide III (compound IIb), an insecticide (compound III) and a herbicide (compound IV).

The present invention relates to a method for improving the plant health of at least one plant variety, which method comprises treating the plant and/or the locus where the plant is growing or is intended to grow with an amide having the formula I (compound I)

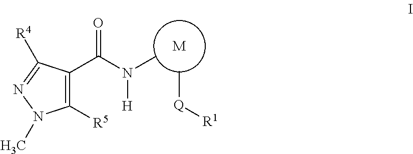

in which the substituents are as defined below:
R⁴ is methyl, difluoromethyl, or trifluoromethyl;
R⁵ is hydrogen or fluorine;
M is a thienyl ring or a phenyl ring, wherein the phenylring is substituted or not substituted with a fluorine atom;
Q is a direct bond, a cyclopropylene or an anellated bicyclo[2.2.1]heptane ring;
R¹ is cyclopropyl, 1,3-dimethylbutyl, isopropyl, phenyl substituted with two or three halogen atoms or a trifluoromethylthio radical.

The present invention relates to a method for improving the plant health of at least one plant variety, which method comprises treating the plant and/or the locus where the plant is growing or is intended to grow with a mixture comprising an amide of the formula I (compound I) and a further fungicide II (compound II) or an insecticide (compound III) or a herbicide (compound IV).

The present invention also relates to a method for improving the plant health of at least one plant variety, which method comprises treating the plant and/or the locus where the plant is growing or is intended to grow with a ternary mixture comprising an amide of the formula I (compound I) and as a second component a further fungicide II (compound II) or an insecticide (compound III) and as a third component either a further fungicide III (compound IIb) or optionally a herbicide (compound IV).

The present invention also relates to a method for improving the plant health of at least one plant variety, which method comprises treating the plant and/or the locus where the plant is growing or is intended to grow with a ternary mixture comprising an amide of the formula I (compound I) and an insecticide (compound III) and a herbicide (compound IV).

The present invention also relates to a method for improving the plant health of at least one plant variety, which method comprises treating the plant and/or the locus where the plant is growing or is intended to grow with a quaternary mixture comprising an amide of the formula I (compound I) and a further fungicide II (compound II) and a further fungicide III (compound IIb) and a herbicide (compound IV).

The present invention also relates to the use of an amide having the formula I (compound I) for improving the the plant health of at least one plant variety.

In crop protection, there is a continuous need for compositions that improve the health of plants. Healthier plants are desirable since they result among others in better crop yields and/or a better quality of the plants or crops. Healthier plants also better resist to abiotic stress.

It was therefore an object of the present invention to provide a pesticidal composition which solves the problems outlined above, and which should, in particular, improve plant health.

We have found that this object is achieved by a method for improving the health of a plant, which comprises treating the plant and/or the locus where the plant is growing or is intended to grow with an amide (compound I) having the formula I (compound I)

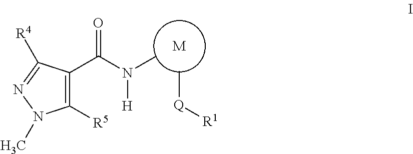

in which the substituents are as defined below:
R⁴ is methyl or trifluoromethyl;
R⁵ is hydrogen or fluorine;
M is a thienyl ring or a phenyl ring, wherein the phenylring is substituted or not substituted with a fluorine atom;
Q is a direct bond, a cyclopropylene or an anellated bicyclo[2.2.1]heptane ring;
R¹ is cyclopropyl, 1,3-dimethylbutyl, isopropyl, phenyl substituted with two or three halogen atoms or a trifluoromethylthio radical.

It was also found that certain fungicidal mixtures showed synergistic plant health effects in the method of the present invention.

Within these mixtures, also synergistic mixtures with synergistic fungicidal activity have been found.

WO 01/82701 discloses a method for inducing resistance of plants against virus infection by repeated application of strobilurin type active compounds. However, repeated application of fungicides may select resistant populations of the harmful fungi.

PCT/EP/2008/051672 discloses that certain anilids induce virus tolerance.

WO 07/104658 comprises a method of inducing tolerance of plants against bacterioses by application of strobilurins with anilid compounds to plants.

WO 05/018324 discloses plant health effects of certain anilid compunds.

Combinations of amides of formula I with several fungicides are disclosed in WO 07/017416, PCT/EP2008/051331, PCT/EP2008/051375, WO 08/000377, WO 07/128756, EP application No. 08152059.5, EP application No. 08155881.9, EP application No. 07119858.4 and PCT/EP2008/051955. However, herein no hints towards synergistic plant health effects are given.

In addition, none of these references discloses the synergistic plant health effects of the mixtures as defined at the outset or describes the synergistic fungicidal mixtures in detail.

The amides of formula I (compound I) are known as fungicides (cf., for example, EP-A 545 099, EP-A 589 301, EP-A 737682, EP-A 824099, WO 99/09013, WO 03/010149, WO 03/070705, WO 03/074491, WO 2004/005242, WO 04/035589, WO 04/067515, WO 06/087343,). They can be prepared in the manner described therein.

The further fungicide II (compound II), the insecticides (compound III) and the herbicides (compound IV) as well as their pesticidal action and methods for producing them are generally known. For instance, the commercially available compounds may be found in The Pesticide Manual, 13th Edition, British Crop Protection Council (2003) among other publications.

The below remarks as to preferred embodiments of amides of the formula I (compound I) and respective mixtures comprising the compounds (I), to their preferred use and methods of using them, are to be understood either each on their own or preferably in combination with each other.

In a preferred embodiment, the amide of the formula I (compound I) is a compound of the formula Ia

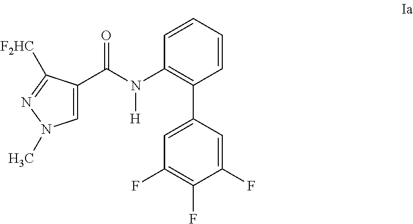

which is N-(3′,4′,5′-trifluorobiphenyl-2-yl)-3-difluoromethyl-1-methyl-1H-pyrazole-4-carboxamide, herein after referred to as “Ia”

According to another preferred embodiment, the amide of the formula I (compound I) is a compound of the formula Ib

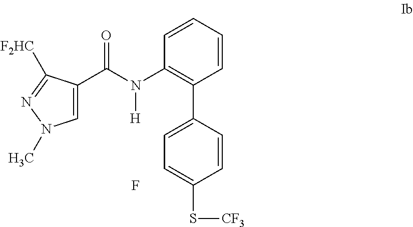

which is N-[2-(4′-trifluoromethylthio)-biphenyl]-3-difluoromethyl-1-methyl-1H-pyrazole-4-carboxamide, herein after referred to as “Ib”

According to a further preferred embodiment, the amide of the formula I (compound I) is a compound of the formula Ic

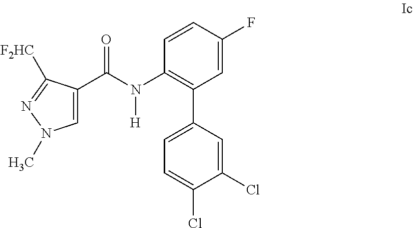

which is N-(3′,4′-dichloro-5-fluorobiphenyl-2-yl)-3-difluoromethyl-1-methylpyrazole-4-carboxamide (common name: bixafen), herein after referred to as “Ic”

According to a further preferred embodiment, the amide of the formula I (compound I) is a compound of the formula Id

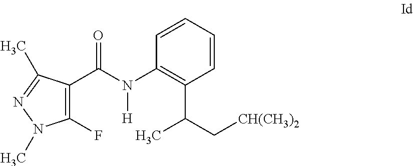

which is N-[2-(1,3-dimethylbutyl)-phenyl]-1,3-dimethyl-5-fluoro-1H-pyrazole-4-carboxamide, herein after referred to as “Id”

According to a further preferred embodiment, the amide of the formula I (compound I) is a compound of the formula Ie

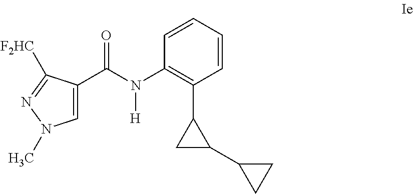

which is N-(2-bicyclopropyl-2-yl-phenyl)-3-difluoromethyl-1-methyl-1H-pyrazole-4-carboxamide, wherein this compound can be found as racemat of its cis-isomers and trans-isomers (common name: sedaxane).

According to a further preferred embodiment, the amide of the formula I (compound I) is a compound of the formula If

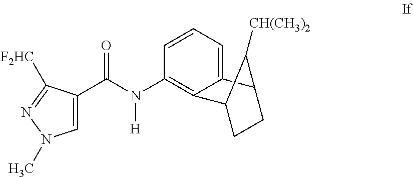

which is N-[1,2,3,4-tetrahydro-9-(1-methylethyl)-1,4-methanonaphthalen-5-yl]-3-(difluoromethyl)-1-methyl-1H-pyrazole-4-carboxamide (common name: isopyrazam), herein after referred to as “If”

According to a further preferred embodiment, the amide of the formula I (compound I) is a compound of the formula Ig

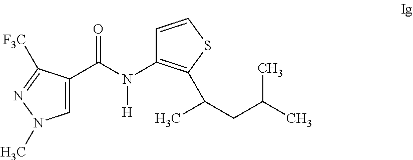

Ig, which is N-[2-(1,3-dimethylbutyl)-3-thienyl]-1-methyl-3-(trifluoromethyl)-1H-pyrazole-4-carboxamide (common name: penthiopyrad), herein after referred to as “Ig”

In a more preferred embodiment, compound (I) is selected from the group consisting of Ia, Ic, Ie, If and Ig.

In an even more preferred embodiment, compound (I) is selected from the group consisting of Ia, Ic, If and Ig, most preferably compound (I) is the compound Ia.

As mentioned at the outset, the present invention also relates to a method for improving the plant health of at least one plant variety, which method comprises treating the plant and/or the locus where the plant is growing or is expected to grow with a compound (I) or with a specified mixture. In one embodiment, this mixture comprises
(1) an amide of the formula I (compound I); and
(2) a further fungicide II (compound II), wherein the further fungicide II is selected from the group consisting of
   (i) strobilurines, selected from azoxystrobin (S1), dimoxystrobin (S2), fluoxastrobin (S3), kresoxim-methyl (S4), metominostrobin (S5), orysastrobin (S6), picoxystrobin (S7), pyraclostrobin (S8) and trifloxystrobin (S9);
   (ii) carboxylic amides, selected from boscalid, fenhexamid, metalaxyl, dimethomorph, fluopicolide (picobenzamid), zoxamide, mandipropamid and carpropamid;
   (iii) azoles, selected from cyproconazole (A1), difenoconazole (A2), epoxiconazole (A3), flusilazole (A4), fluquinconazole (A5), flutriafol (A6), ipconazole (A7), metconazole (A8), propiconazole (A9), prothioconazole (A10), tebuconazole (A11), cyazofamid (A12), prochloraz (A13), ethaboxam (A14) and triazoxide (A15);
   (iv) heterocyclic compounds, selected from famoxadone, fluazinam, cyprodinil, pyrimethanil, fenpropimorph, iprodione, acibenzolar-S-methyl, proquinazid, quinoxyfen, fenpiclonil, captan, fenpropidin, captafol and anilazin;
   (v) carbamates and dithiocarbannates, selected from mancozeb, metiram, iprovalicarb, maneb, propineb, flubenthiavalicarb (benthiavalicarb) and propamocarb;
   (vi) organo-chloro compounds, selected from thiophanate methyl, chlorothalonil, tolylfluanid and flusulfamid;
   (vii) inorganic active ingredients, selected from Bordeaux composition, copper acetate, copper hydroxide, copper oxychloride, basic copper sulfate and sulfur;
   (viii) various, selected from spiroxamine, guazatin, cymoxanil, cyflufenamid, valiphenal, metrafenone; fosetly-aluminium and dithianon;
   (3) and as a third component optionally a further fungicide III (compound IIb), wherein the further fungicide III is selected from the group consisting of
   (iii) azoles, selected from cyproconazole (A1), difenoconazole (A2), epoxiconazole (A3), flusilazole (A4), fluquinconazole (A5), flutriafol (A6), ipconazole (A7), metconazole (A8), propiconazole (A9), prothioconazole (A10), tebuconazole (A11), cyazofamid (A12), prochloraz (A13), ethaboxam (A14) and triazoxide (A15);
   (4) or as a third component optionally a herbicide (compound IV), wherein the herbicide is selected from the group consisting of glyphosate (H1), glyphosinate (H2) and sulfonisate (H3).
      in plant health synergistically effective amounts.

The term “plant health effective amount” denotes an amount of the compound (I) or the mixtures of compound (I) and at least one compound selected from the group consisting of the compounds (II), (IIb), (III) and (IV), which is sufficient for achieving plant health effects as defined herein below. More exemplary information about amounts, ways of application and suitable ratios to be used is given below. Anyway, the skilled artisan is well aware of the fact that such an amount can vary in a broad range and is dependent on various factors, e.g. the treated cultivated plant or material and the climatic conditions.

The term “synergistic” means that the simultaneous, that is joint or separate, application of the compound (I) and at least one compound of the group consisting of the compounds (II), (IIb), (III) and (IV), or the successive application of the compound (I) and at least one compound of the group consisting of the compounds (II), (IIb), (III) and (IV), provides enhanced plant health effects compared to the plant health effects that are possible with the individual compounds.

Preferably, the further fungicide II (compound II) is selected from the group consisting of
(i) strobilurines, selected from azoxystrobin (S1), dimoxystrobin (S2), orysastrobin (S6), picoxystrobin (S7), pyraclostrobin (S8) and trifloxystrobin (S9);
(ii) carboxcyclic amides, selected from boscalid and dimethomorph;
(iii) azoles, selected from cyproconazole (A1), difenoconazole (A2), epoxiconazole (A3), metconazole (A8), propiconazole (A9), prothioconazole (A10) and tebuconazole (A11);
(iv) heterocyclic compounds, selected from cyprodinil, pyrimethanil, fenpropimorph, iprodione, quinoxyfen and acibenzolar-S-methyl;
(v) carbamates and dithiocarbamates, selected from mancozeb, metiram, propineb and iprovalicarb;
(viii) various, selected from dithianon and metrafenone.

Preferably, the further fungicide III (compound IIb) is selected from the group consisting of
(iii) azoles, selected from cyproconazole (A1), difenoconazole (A2), epoxiconazole (A3), metconazole (A8), propiconazole (A9), prothioconazole (A10) and tebuconazole (A11).

The preferred herbicide (compound IV) is glyphosate (H1).

More preferably, the further fungicide II (compound II) is selected from the group consisting of:
(i) strobilurines, selected from azoxystrobin (S1), orysastrobin (S6), pyraclostrobin (S8), trifloxystrobin (S9)
(iii) azoles, selected from epoxiconazole (A3), metconazole (A8), propiconazole (A9), prothioconazole (A10) and tebuconazole (A11).

Most preferably, the further fungicide II (compound II) is selected from the group consisting of azoxystrobin (S1), orysastrobin (S6), pyraclostrobin (S8), and trifloxystrobin (S9), wherein orysastrobin (S6) and pyraclostrobin (S8) are the utmost preferred fungicides II.

Most preferably, the further fungicide III (compound IIb) is selected from the group consisting of epoxiconazole (A3), metconazole (A8), propiconazole (A9), prothioconazole (A10) and tebuconazole (A11).

In the terms of the present invention “mixture” is not restricted to a physical mixture containing compounds (I) and at least one compound selected from the group consisting of compounds (II), (IIb), (III) and (IV) but refers to any preparation form of compounds (I) and at least one compound selected from the group consisting of compounds (II), (IIb), (III) and (IV), the use of which is time- and locus-related.

In one embodiment of the invention “mixture” refers to a physical mixture of the compound (I) (=one compound I) and one compound selected from the group consisting of compounds (II), (IIb), (III) and (IV), (=one of the specific fungicides II or the specific fungicides IIb or one of the insecticides III or one of the herbicides IV as defined).

In another embodiment of the invention, “mixture” refers to ternary mixtures comprising a compound (I) and one compound (II) and one compound selected from the group consisting of (IIb), (III) and (IV).

In another embodiment of the invention, “mixture” refers to quaternary mixtures comprising a compound (I) and one compound (II) and two compounds selected from the group consisting of (IIb), (III) and (IV).

In another embodiment of the invention, “mixture” refers to the compounds (I) and at least one compound selected from the group consisting of compounds (II), (IIb), (III) ornd (IV), formulated separately but applied to the same plant or locus, where the plant grows or intends to grow in a temporal relationship, i.e. simultaneously or subsequently, the subsequent application having a time interval which allows a combined action of the compounds.

Furthermore, the individual compounds of the mixtures according to the invention such as parts of a kit or parts of the binary mixture may be mixed by the user himself in a spray tank and further auxiliaries may be added, if appropriate (tank mix).

In another embodiment, these mixtures comprise
(I) an amide compound of the formula I (compound I) and
(III) an insecticide (compound III) selected from the group consisting of fipronil (Fip) and ethiprole (Ethi).
   in synergistically plant health effective amounts.

The preferred insecticide (compound III) is fipronil (Fip).

Preferably, all above-mentioned mixtures comprise either Ia, Ib, Ic, Id, Ie, If or Ig as compound (I).

More preferably, these mixtures comprise either Ia, Ic, If or Ig as compound (I). Most preferably, these mixtures comprise either Ia, Ic or If as compound (I).

In a particular preferred embodiment, these mixtures comprise Ia as compound (I).

Thus, with respect to their intended use in the methods of the present invention, the following secondary mixtures of compound (I) and compounds (II) or (III) or (IV), listed in the table below are a preferred embodiment of the present invention:

TABLE 1

| No. | (I) | (II) or (III) or (IV) |
|---|---|---|
| M-1 | Ia | azoxystrobin |
| M-2 | Ia | orysastrobin |
| M-3 | Ia | pyraclostrobin |
| M-4 | Ia | trifloxystrobin |
| M-5 | Ia | epoxiconazole |
| M-6 | Ia | metconazole |
| M-7 | Ia | prothioconazole |
| M-8 | Ia | tebuconazole |
| M-9 | Ia | propiconazole |
| M-10 | Ia | fipronil |
| M-11 | Ia | boscalid |
| M-12 | Ia | dimethomorph |
| M-13 | Ia | cyproconazole |
| M-14 | Ia | difenoconazole |
| M-15 | Ia | cyprodinil |
| M-16 | Ia | pyrimethanil |
| M-17 | Ia | fenpropimorph |
| M-18 | Ia | iprodione |
| M-19 | Ia | quinoxyfen |
| M-20 | Ia | acibenzolar-S-methyl |
| M-21 | Ia | mancozeb |
| M-22 | Ia | metiram |
| M-23 | Ia | propineb |
| M-24 | Ia | iprovalicarb |
| M-25 | Ia | dithianon |
| M-26 | Ia | metrafenone |
| M-27 | Ic | azoxystrobin |
| M-28 | Ic | orysastrobin |
| M-29 | Ic | pyraclostrobin |
| M-30 | Ic | trifloxystrobin |
| M-31 | Ic | epoxiconazole |
| M-32 | Ic | metconazole |
| M-33 | Ic | prothioconazole |
| M-34 | Ic | tebuconazole |
| M-35 | Ic | propiconazole |
| M-36 | Ic | fipronil |
| M-37 | Ic | boscalid |
| M-38 | Ic | dimethomorph |
| M-39 | Ic | cyproconazole |
| M-40 | Ic | difenoconazole |
| M-41 | Ic | cyprodinil |
| M-42 | Ic | pyrimethanil |
| M-43 | Ic | fenpropimorph |
| M-44 | Ic | iprodione |
| M-45 | Ic | quinoxyfen |
| M-46 | Ic | acibenzolar-S-methyl |
| M-47 | Ic | mancozeb |
| M-48 | Ic | metiram |
| M-49 | Ic | propineb |
| M-50 | Ic | iprovalicarb |
| M-51 | Ic | dithianon |
| M-52 | Ic | metrafenone |
| M-53 | If | azoxystrobin |
| M-54 | If | orysastrobin |
| M-55 | If | pyraclostrobin |
| M-56 | If | trifloxystrobin |
| M-57 | If | epoxiconazole |
| M-58 | If | metconazole |
| M-59 | If | prothioconazole |
| M-60 | If | tebuconazole |
| M-61 | If | propiconazole |
| M-62 | If | fipronil |
| M-63 | If | boscalid |
| M-64 | If | dimethomorph |
| M-65 | If | cyproconazole |
| M-66 | If | difenoconazole |
| M-67 | If | cyprodinil |
| M-68 | If | pyrimethanil |
| M-69 | If | fenpropimorph |
| M-70 | If | iprodione |
| M-71 | If | quinoxyfen |
| M-72 | If | acibenzolar-S-methyl |
| M-73 | If | mancozeb |
| M-74 | If | metiram |
| M-75 | If | propineb |
| M-76 | If | iprovalicarb |
| M-77 | If | dithianon |
| M-78 | If | metrafenone |
| M-79 | Ig | azoxystrobin |
| M-80 | Ig | orysastrobin |
| M-81 | Ig | pyraclostrobin |
| M-82 | Ig | trifloxystrobin |
| M-83 | Ig | epoxiconazole |
| M-84 | Ig | metconazole |
| M-85 | Ig | prothioconazole |
| M-86 | Ig | tebuconazole |
| M-87 | Ig | propiconazole |
| M-88 | Ig | fipronil |
| M-89 | Ig | boscalid |
| M-90 | Ig | dimethomorph |
| M-91 | Ig | cyproconazole |
| M-92 | Ig | difenoconazole |
| M-93 | Ig | cyprodinil |
| M-94 | Ig | pyrimethanil |
| M-95 | Ig | fenpropimorph |
| M-96 | Ig | iprodione |
| M-97 | Ig | quinoxyfen |
| M-98 | Ig | acibenzolar-S-methyl |
| M-99 | Ig | mancozeb |
| M-100 | Ig | metiram |
| M-101 | Ig | propineb |
| M-102 | Ig | iprovalicarb |
| M-103 | Ig | dithianon |
| M-104 | Ig | metrafenone |
| M-105 | Ia | glyphosate |
| M-106 | Ib | glyphosate |
| M-107 | Ic | glyphosate |
| M-108 | Id | glyphosate |
| M-109 | Ie | glyphosate |
| M-110 | If | glyphosate |
| M-111 | Ig | glyphosate |

Within the mixtures of table 1, the following mixtures are especially preferred: M-1, M-2, M-3, M-4, M-5, M-6, M-7, M-8, M-9, M-10, M-27, M-28, M-29, M-30, M-31, M-32, M-33, M-34, M-35, M-36, M-53, M-54, M-55, M-56, M-57, M-58, M-59, M-60, M-61, M-61, M-62, M-79, M-80, M-81, M-82, M-83, M-84, M-85, M-86, M-87, M-88, M-105, M-106, M-107, M-108, M-109, M-110 and M-111.

Within this subset, the following mixtures are more preferred:

M-1, M-2, M-3, M-4,M-10, M-27, M-28, M-29, M-30, M-36, M-53, M-54, M-55, M-56, M-62, M-79, M-80, M-81, M-82, M-88, M-105, M-107, M-110 and M-111

The following mixtures are even more preferred: M-1, M-2, M-3, M-4, M-27, M-28, M-29, M-30, M-53, M-54, M-55, M-56, M-79, M-80, M-81, M-82 and M-105

The following mixtures are most preferred: M-2, M-3, M-28, M-29, M-54, M-55, M-80, M-81 and M-105.

Utmost preference is given to mixtures M-2, M-3 and M-105.

With respect to their intended use within the methods of the present invention, the following ternary mixtures of compound (I) and compounds (II) or (III) in combination with compounds (IIb) or (IV) listed in the table 2 below are a prefered embodiment of the present invention.

The mixtures disclosed in table 2 are also a further embodiment of the present invention.

TABLE 2

| | | (II) | (IIb) |
|---|---|---|---|
| | | or | or |
| No. | (I) | (III) | (IV) |
| N-1 | Ia | S1 | A1 |
| N-2 | Ia | S1 | A2 |
| N-3 | Ia | S1 | A3 |
| N-4 | Ia | S1 | A4 |
| N-5 | Ia | S1 | A5 |
| N-6 | Ia | S1 | A6 |
| N-7 | Ia | S1 | A7 |
| N-8 | Ia | S1 | A8 |
| N-9 | Ia | S1 | A9 |
| N-10 | Ia | S1 | A10 |
| N-11 | Ia | S1 | A11 |
| N-12 | Ia | S1 | A12 |
| N-13 | Ia | S1 | A13 |
| N-14 | Ia | S1 | A14 |
| N-15 | Ia | S1 | A15 |
| N-16 | Ia | S2 | A1 |
| N-17 | Ia | S2 | A2 |
| N-18 | Ia | S2 | A3 |
| N-19 | Ia | S2 | A4 |
| N-20 | Ia | S2 | A5 |
| N-21 | Ia | S2 | A6 |
| N-22 | Ia | S2 | A7 |
| N-23 | Ia | S2 | A8 |
| N-24 | Ia | S2 | A9 |
| N-25 | Ia | S2 | A10 |
| N-26 | Ia | S2 | A11 |
| N-27 | Ia | S2 | A12 |
| N-28 | Ia | S2 | A13 |
| N-29 | Ia | S2 | A14 |
| N-30 | Ia | S2 | A15 |
| N-31 | Ia | S3 | A1 |
| N-32 | Ia | S3 | A2 |
| N-33 | Ia | S3 | A3 |
| N-34 | Ia | S3 | A4 |
| N-35 | Ia | S3 | A5 |
| N-36 | Ia | S3 | A6 |
| N-37 | Ia | S3 | A7 |
| N-38 | Ia | S3 | A8 |
| N-39 | Ia | S3 | A9 |
| N-40 | Ia | S3 | A10 |
| N-41 | Ia | S3 | A11 |
| N-42 | Ia | S3 | A12 |
| N-43 | Ia | S3 | A13 |
| N-44 | Ia | S3 | A14 |
| N-45 | Ia | S3 | A15 |
| N-46 | Ia | S4 | A1 |
| N-47 | Ia | S4 | A2 |
| N-48 | Ia | S4 | A3 |
| N-49 | Ia | S4 | A4 |
| N-50 | Ia | S4 | A5 |
| N-51 | Ia | S4 | A6 |
| N-52 | Ia | S4 | A7 |
| N-53 | Ia | S4 | A8 |
| N-54 | Ia | S4 | A9 |
| N-55 | Ia | S4 | A10 |
| N-56 | Ia | S4 | A11 |
| N-57 | Ia | S4 | A12 |
| N-58 | Ia | S4 | A13 |
| N-59 | Ia | S4 | A14 |
| N-60 | Ia | S4 | A15 |
| N-61 | Ia | S5 | A1 |
| N-62 | Ia | S5 | A2 |
| N-63 | Ia | S5 | A3 |
| N-64 | Ia | S5 | A4 |
| N-65 | Ia | S5 | A5 |
| N-66 | Ia | S5 | A6 |
| N-67 | Ia | S5 | A7 |
| N-68 | Ia | S5 | A8 |
| N-69 | Ia | S5 | A9 |
| N-70 | Ia | S5 | A10 |
| N-71 | Ia | S5 | A11 |
| N-72 | Ia | S5 | A12 |
| N-73 | Ia | S5 | A13 |
| N-74 | Ia | S5 | A14 |
| N-75 | Ia | S5 | A15 |
| N-76 | Ia | S6 | A1 |
| N-77 | Ia | S6 | A2 |
| N-78 | Ia | S6 | A3 |
| N-79 | Ia | S6 | A4 |
| N-80 | Ia | S6 | A5 |
| N-81 | Ia | S6 | A6 |
| N-82 | Ia | S6 | A7 |
| N-83 | Ia | S6 | A8 |
| N-84 | Ia | S6 | A9 |
| N-85 | Ia | S6 | A10 |
| N-86 | Ia | S6 | A11 |
| N-87 | Ia | S6 | A12 |
| N-88 | Ia | S6 | A13 |
| N-89 | Ia | S6 | A14 |
| N-90 | Ia | S6 | A15 |
| N-91 | Ia | S7 | A1 |
| N-92 | Ia | S7 | A2 |
| N-93 | Ia | S7 | A3 |
| N-94 | Ia | S7 | A4 |
| N-95 | Ia | S7 | A5 |
| N-96 | Ia | S7 | A6 |
| N-97 | Ia | S7 | A7 |
| N-98 | Ia | S7 | A8 |
| N-99 | Ia | S7 | A9 |
| N-100 | Ia | S7 | A10 |
| N-101 | Ia | S7 | A11 |
| N-102 | Ia | S7 | A12 |
| N-103 | Ia | S7 | A13 |
| N-104 | Ia | S7 | A14 |
| N-105 | Ia | S7 | A15 |
| N-106 | Ia | S8 | A1 |
| N-107 | Ia | S8 | A2 |
| N-108 | Ia | S8 | A3 |
| N-109 | Ia | S8 | A4 |
| N-110 | Ia | S8 | A5 |
| N-111 | Ia | S8 | A6 |
| N-112 | Ia | S8 | A7 |
| N-113 | Ia | S8 | A8 |
| N-114 | Ia | S8 | A9 |
| N-115 | Ia | S8 | A10 |
| N-116 | Ia | S8 | A11 |
| N-117 | Ia | S8 | A12 |
| N-118 | Ia | S8 | A13 |
| N-119 | Ia | S8 | A14 |
| N-120 | Ia | S8 | A15 |
| N-121 | Ia | S9 | A1 |
| N-122 | Ia | S9 | A2 |
| N-123 | Ia | S9 | A3 |
| N-124 | Ia | S9 | A4 |
| N-125 | Ia | S9 | A5 |
| N-126 | Ia | S9 | A6 |
| N-127 | Ia | S9 | A7 |
| N-128 | Ia | S9 | A8 |
| N-129 | Ia | S9 | A9 |
| N-130 | Ia | S9 | A10 |
| N-131 | Ia | S9 | A11 |
| N-132 | Ia | S9 | A12 |
| N-133 | Ia | S9 | A13 |
| N-134 | Ia | S9 | A14 |
| N-135 | Ia | S9 | A15 |
| N-136 | Ib | S1 | A1 |
| N-137 | Ib | S1 | A2 |
| N-138 | Ib | S1 | A3 |
| N-139 | Ib | S1 | A4 |
| N-140 | Ib | S1 | A5 |
| N-141 | Ib | S1 | A6 |
| N-142 | Ib | S1 | A7 |
| N-143 | Ib | S1 | A8 |
| N-144 | Ib | S1 | A9 |
| N-145 | Ib | S1 | A10 |
| N-146 | Ib | S1 | A11 |
| N-147 | Ib | S1 | A12 |
| N-148 | Ib | S1 | A13 |
| N-149 | Ib | S1 | A14 |
| N-150 | Ib | S1 | A15 |
| N-151 | Ib | S2 | A1 |
| N-152 | Ib | S2 | A2 |
| N-153 | Ib | S2 | A3 |
| N-154 | Ib | S2 | A4 |
| N-155 | Ib | S2 | A5 |
| N-156 | Ib | S2 | A6 |
| N-157 | Ib | S2 | A7 |
| N-158 | Ib | S2 | A8 |
| N-159 | Ib | S2 | A9 |
| N-160 | Ib | S2 | A10 |
| N-161 | Ib | S2 | A11 |
| N-162 | Ib | S2 | A12 |
| N-163 | Ib | S2 | A13 |
| N-164 | Ib | S2 | A14 |
| N-165 | Ib | S2 | A15 |
| N-166 | Ib | S3 | A1 |
| N-167 | Ib | S3 | A2 |
| N-168 | Ib | S3 | A3 |
| N-169 | Ib | S3 | A4 |
| N-170 | Ib | S3 | A5 |
| N-171 | Ib | S3 | A6 |
| N-172 | Ib | S3 | A7 |
| N-173 | Ib | S3 | A8 |
| N-174 | Ib | S3 | A9 |
| N-175 | Ib | S3 | A10 |
| N-176 | Ib | S3 | A11 |
| N-177 | Ib | S3 | A12 |
| N-178 | Ib | S3 | A13 |
| N-179 | Ib | S3 | A14 |
| N-180 | Ib | S3 | A15 |
| N-181 | Ib | S4 | A1 |
| N-182 | Ib | S4 | A2 |
| N-183 | Ib | S4 | A3 |
| N-184 | Ib | S4 | A4 |
| N-185 | Ib | S4 | A5 |
| N-186 | Ib | S4 | A6 |
| N-187 | Ib | S4 | A7 |
| N-188 | Ib | S4 | A8 |
| N-189 | Ib | S4 | A9 |
| N-190 | Ib | S4 | A10 |
| N-191 | Ib | S4 | A11 |
| N-192 | Ib | S4 | A12 |
| N-193 | Ib | S4 | A13 |
| N-194 | Ib | S4 | A14 |
| N-195 | Ib | S4 | A15 |
| N-196 | Ib | S5 | A1 |
| N-197 | Ib | S5 | A2 |
| N-198 | Ib | S5 | A3 |
| N-199 | Ib | S5 | A4 |
| N-200 | Ib | S5 | A5 |
| N-201 | Ib | S5 | A6 |
| N-202 | Ib | S5 | A7 |
| N-203 | Ib | S5 | A8 |
| N-204 | Ib | S5 | A9 |
| N-205 | Ib | S5 | A10 |
| N-206 | Ib | S5 | A11 |
| N-207 | Ib | S5 | A12 |
| N-208 | Ib | S5 | A13 |
| N-209 | Ib | S5 | A14 |
| N-210 | Ib | S5 | A15 |
| N-211 | Ib | S6 | A1 |
| N-212 | Ib | S6 | A2 |
| N-213 | Ib | S6 | A3 |
| N-214 | Ib | S6 | A4 |
| N-215 | Ib | S6 | A5 |
| N-216 | Ib | S6 | A6 |
| N-217 | Ib | S6 | A7 |
| N-218 | Ib | S6 | A8 |
| N-219 | Ib | S6 | A9 |
| N-220 | Ib | S6 | A10 |
| N-221 | Ib | S6 | A11 |
| N-222 | Ib | S6 | A12 |
| N-223 | Ib | S6 | A13 |
| N-224 | Ib | S6 | A14 |
| N-225 | Ib | S6 | A15 |
| N-226 | Ib | S7 | A1 |
| N-227 | Ib | S7 | A2 |
| N-228 | Ib | S7 | A3 |
| N-229 | Ib | S7 | A4 |
| N-230 | Ib | S7 | A5 |
| N-231 | Ib | S7 | A6 |
| N-232 | Ib | S7 | A7 |
| N-233 | Ib | S7 | A8 |
| N-234 | Ib | S7 | A9 |
| N-235 | Ib | S7 | A10 |
| N-236 | Ib | S7 | A11 |
| N-237 | Ib | S7 | A12 |
| N-238 | Ib | S7 | A13 |
| N-239 | Ib | S7 | A14 |
| N-240 | Ib | S7 | A15 |
| N-241 | Ib | S8 | A1 |
| N-242 | Ib | S8 | A2 |
| N-243 | Ib | S8 | A3 |
| N-244 | Ib | S8 | A4 |
| N-245 | Ib | S8 | A5 |
| N-246 | Ib | S8 | A6 |
| N-247 | Ib | S8 | A7 |
| N-248 | Ib | S8 | A8 |
| N-249 | Ib | S8 | A9 |
| N-250 | Ib | S8 | A10 |
| N-251 | Ib | S8 | A11 |
| N-252 | Ib | S8 | A12 |
| N-253 | Ib | S8 | A13 |
| N-254 | Ib | S8 | A14 |
| N-255 | Ib | S8 | A15 |
| N-256 | Ib | S9 | A1 |
| N-257 | Ib | S9 | A2 |
| N-258 | Ib | S9 | A3 |
| N-259 | Ib | S9 | A4 |
| N-260 | Ib | S9 | A5 |
| N-261 | Ib | S9 | A6 |
| N-262 | Ib | S9 | A7 |
| N-263 | Ib | S9 | A8 |
| N-264 | Ib | S9 | A9 |
| N-265 | Ib | S9 | A10 |
| N-266 | Ib | S9 | A11 |
| N-267 | Ib | S9 | A12 |
| N-268 | Ib | S9 | A13 |
| N-269 | Ib | S9 | A14 |
| N-270 | Ib | S9 | A15 |
| N-271 | Ic | S1 | A1 |
| N-272 | Ic | S1 | A2 |
| N-273 | Ic | S1 | A3 |
| N-274 | Ic | S1 | A4 |
| N-275 | Ic | S1 | A5 |
| N-276 | Ic | S1 | A6 |
| N-277 | Ic | S1 | A7 |
| N-278 | Ic | S1 | A8 |
| N-279 | Ic | S1 | A9 |
| N-280 | Ic | S1 | A10 |
| N-281 | Ic | S1 | A11 |
| N-282 | Ic | S1 | A12 |
| N-283 | Ic | S1 | A13 |
| N-284 | Ic | S1 | A14 |
| N-285 | Ic | S1 | A15 |
| N-286 | Ic | S2 | A1 |
| N-287 | Ic | S2 | A2 |
| N-288 | Ic | S2 | A3 |
| N-289 | Ic | S2 | A4 |
| N-290 | Ic | S2 | A5 |
| N-291 | Ic | S2 | A6 |
| N-292 | Ic | S2 | A7 |
| N-293 | Ic | S2 | A8 |
| N-294 | Ic | S2 | A9 |
| N-295 | Ic | S2 | A10 |
| N-296 | Ic | S2 | A11 |
| N-297 | Ic | S2 | A12 |
| N-298 | Ic | S2 | A13 |
| N-299 | Ic | S2 | A14 |
| N-300 | Ic | S2 | A15 |
| N-301 | Ic | S3 | A1 |
| N-302 | Ic | S3 | A2 |
| N-303 | Ic | S3 | A3 |
| N-304 | Ic | S3 | A4 |
| N-305 | Ic | S3 | A5 |
| N-306 | Ic | S3 | A6 |
| N-307 | Ic | S3 | A7 |
| N-308 | Ic | S3 | A8 |
| N-309 | Ic | S3 | A9 |
| N-310 | Ic | S3 | A10 |
| N-311 | Ic | S3 | A11 |
| N-312 | Ic | S3 | A12 |
| N-313 | Ic | S3 | A13 |
| N-314 | Ic | S3 | A14 |
| N-315 | Ic | S3 | A15 |
| N-316 | Ic | S4 | A1 |
| N-317 | Ic | S4 | A2 |
| N-318 | Ic | S4 | A3 |
| N-319 | Ic | S4 | A4 |
| N-320 | Ic | S4 | A5 |
| N-321 | Ic | S4 | A6 |
| N-322 | Ic | S4 | A7 |
| N-323 | Ic | S4 | A8 |
| N-324 | Ic | S4 | A9 |
| N-325 | Ic | S4 | A10 |
| N-326 | Ic | S4 | A11 |
| N-327 | Ic | S4 | A12 |
| N-328 | Ic | S4 | A13 |
| N-329 | Ic | S4 | A14 |
| N-330 | Ic | S4 | A15 |
| N-331 | Ic | S5 | A1 |
| N-332 | Ic | S5 | A2 |
| N-333 | Ic | S5 | A3 |
| N-334 | Ic | S5 | A4 |
| N-335 | Ic | S5 | A5 |
| N-336 | Ic | S5 | A6 |
| N-337 | Ic | S5 | A7 |
| N-338 | Ic | S5 | A8 |
| N-339 | Ic | S5 | A9 |
| N-340 | Ic | S5 | A10 |
| N-341 | Ic | S5 | A11 |
| N-342 | Ic | S5 | A12 |
| N-343 | Ic | S5 | A13 |
| N-344 | Ic | S5 | A14 |
| N-345 | Ic | S5 | A15 |
| N-346 | Ic | S6 | A1 |
| N-347 | Ic | S6 | A2 |
| N-348 | Ic | S6 | A3 |
| N-349 | Ic | S6 | A4 |
| N-350 | Ic | S6 | A5 |
| N-351 | Ic | S6 | A6 |
| N-352 | Ic | S6 | A7 |
| N-353 | Ic | S6 | A8 |
| N-354 | Ic | S6 | A9 |
| N-355 | Ic | S6 | A10 |
| N-356 | Ic | S6 | A11 |
| N-357 | Ic | S6 | A12 |
| N-358 | Ic | S6 | A13 |
| N-359 | Ic | S6 | A14 |
| N-360 | Ic | S6 | A15 |
| N-361 | Ic | S7 | A1 |
| N-362 | Ic | S7 | A2 |
| N-363 | Ic | S7 | A3 |
| N-364 | Ic | S7 | A4 |
| N-365 | Ic | S7 | A5 |
| N-366 | Ic | S7 | A6 |
| N-367 | Ic | S7 | A7 |
| N-368 | Ic | S7 | A8 |
| N-369 | Ic | S7 | A9 |
| N-370 | Ic | S7 | A10 |
| N-371 | Ic | S7 | A11 |
| N-372 | Ic | S7 | A12 |
| N-373 | Ic | S7 | A13 |
| N-374 | Ic | S7 | A14 |
| N-375 | Ic | S7 | A15 |
| N-376 | Ic | S8 | A1 |
| N-377 | Ic | S8 | A2 |
| N-378 | Ic | S8 | A3 |
| N-379 | Ic | S8 | A4 |
| N-380 | Ic | S8 | A5 |
| N-381 | Ic | S8 | A6 |
| N-382 | Ic | S8 | A7 |
| N-383 | Ic | S8 | A8 |
| N-384 | Ic | S8 | A9 |
| N-385 | Ic | S8 | A10 |
| N-386 | Ic | S8 | A11 |
| N-387 | Ic | S8 | A12 |
| N-388 | Ic | S8 | A13 |
| N-389 | Ic | S8 | A14 |
| N-390 | Ic | S8 | A15 |
| N-391 | Ic | S9 | A1 |
| N-392 | Ic | S9 | A2 |
| N-393 | Ic | S9 | A3 |
| N-394 | Ic | S9 | A4 |
| N-395 | Ic | S9 | A5 |
| N-396 | Ic | S9 | A6 |
| N-397 | Ic | S9 | A7 |
| N-398 | Ic | S9 | A8 |
| N-399 | Ic | S9 | A9 |
| N-400 | Ic | S9 | A10 |
| N-401 | Ic | S9 | A11 |
| N-402 | Ic | S9 | A12 |
| N-403 | Ic | S9 | A13 |
| N-404 | Ic | S9 | A14 |
| N-405 | Ic | S9 | A15 |
| N-406 | Id | S1 | A1 |
| N-407 | Id | S1 | A2 |
| N-408 | Id | S1 | A3 |
| N-409 | Id | S1 | A4 |
| N-410 | Id | S1 | A5 |
| N-411 | Id | S1 | A6 |
| N-412 | Id | S1 | A7 |
| N-413 | Id | S1 | A8 |
| N-414 | Id | S1 | A9 |
| N-415 | Id | S1 | A10 |
| N-416 | Id | S1 | A11 |
| N-417 | Id | S1 | A12 |
| N-418 | Id | S1 | A13 |
| N-419 | Id | S1 | A14 |
| N-420 | Id | S1 | A15 |
| N-421 | Id | S2 | A1 |
| N-422 | Id | S2 | A2 |
| N-423 | Id | S2 | A3 |
| N-424 | Id | S2 | A4 |
| N-425 | Id | S2 | A5 |
| N-426 | Id | S2 | A6 |
| N-427 | Id | S2 | A7 |
| N-428 | Id | S2 | A8 |
| N-429 | Id | S2 | A9 |
| N-430 | Id | S2 | A10 |
| N-431 | Id | S2 | A11 |
| N-432 | Id | S2 | A12 |
| N-433 | Id | S2 | A13 |
| N-434 | Id | S2 | A14 |
| N-435 | Id | S2 | A15 |
| N-436 | Id | S3 | A1 |
| N-437 | Id | S3 | A2 |
| N-438 | Id | S3 | A3 |
| N-439 | Id | S3 | A4 |
| N-440 | Id | S3 | A5 |
| N-441 | Id | S3 | A6 |
| N-442 | Id | S3 | A7 |
| N-443 | Id | S3 | A8 |
| N-444 | Id | S3 | A9 |
| N-445 | Id | S3 | A10 |
| N-446 | Id | S3 | A11 |
| N-447 | Id | S3 | A12 |
| N-448 | Id | S3 | A13 |
| N-449 | Id | S3 | A14 |
| N-450 | Id | S3 | A15 |
| N-451 | Id | S4 | A1 |
| N-452 | Id | S4 | A2 |
| N-453 | Id | S4 | A3 |
| N-454 | Id | S4 | A4 |
| N-455 | Id | S4 | A5 |
| N-456 | Id | S4 | A6 |
| N-457 | Id | S4 | A7 |
| N-458 | Id | S4 | A8 |
| N-459 | Id | S4 | A9 |
| N-460 | Id | S4 | A10 |
| N-461 | Id | S4 | A11 |
| N-462 | Id | S4 | A12 |
| N-463 | Id | S4 | A13 |
| N-464 | Id | S4 | A14 |
| N-465 | Id | S4 | A15 |
| N-466 | Id | S5 | A1 |
| N-467 | Id | S5 | A2 |
| N-468 | Id | S5 | A3 |
| N-469 | Id | S5 | A4 |
| N-470 | Id | S5 | A5 |
| N-471 | Id | S5 | A6 |
| N-472 | Id | S5 | A7 |
| N-473 | Id | S5 | A8 |
| N-474 | Id | S5 | A9 |
| N-475 | Id | S5 | A10 |
| N-476 | Id | S5 | A11 |
| N-477 | Id | S5 | A12 |
| N-478 | Id | S5 | A13 |
| N-479 | Id | S5 | A14 |
| N-480 | Id | S5 | A15 |
| N-481 | Id | S6 | A1 |
| N-482 | Id | S6 | A2 |
| N-483 | Id | S6 | A3 |
| N-484 | Id | S6 | A4 |
| N-485 | Id | S6 | A5 |
| N-486 | Id | S6 | A6 |
| N-487 | Id | S6 | A7 |
| N-488 | Id | S6 | A8 |
| N-489 | Id | S6 | A9 |
| N-490 | Id | S6 | A10 |
| N-491 | Id | S6 | A11 |
| N-492 | Id | S6 | A12 |
| N-493 | Id | S6 | A13 |
| N-494 | Id | S6 | A14 |
| N-495 | Id | S6 | A15 |
| N-496 | Id | S7 | A1 |
| N-497 | Id | S7 | A2 |
| N-498 | Id | S7 | A3 |
| N-499 | Id | S7 | A4 |
| N-500 | Id | S7 | A5 |
| N-501 | Id | S7 | A6 |
| N-502 | Id | S7 | A7 |
| N-503 | Id | S7 | A8 |
| N-504 | Id | S7 | A9 |
| N-505 | Id | S7 | A10 |
| N-506 | Id | S7 | A11 |
| N-507 | Id | S7 | A12 |
| N-508 | Id | S7 | A13 |
| N-509 | Id | S7 | A14 |
| N-510 | Id | S7 | A15 |
| N-511 | Id | S8 | A1 |
| N-512 | Id | S8 | A2 |
| N-513 | Id | S8 | A3 |
| N-514 | Id | S8 | A4 |
| N-515 | Id | S8 | A5 |
| N-516 | Id | S8 | A6 |
| N-517 | Id | S8 | A7 |
| N-518 | Id | S8 | A8 |
| N-519 | Id | S8 | A9 |
| N-520 | Id | S8 | A10 |
| N-521 | Id | S8 | A11 |
| N-522 | Id | S8 | A12 |
| N-523 | Id | S8 | A13 |
| N-524 | Id | S8 | A14 |
| N-525 | Id | S8 | A15 |
| N-526 | Id | S9 | A1 |
| N-527 | Id | S9 | A2 |
| N-528 | Id | S9 | A3 |
| N-529 | Id | S9 | A4 |
| N-530 | Id | S9 | A5 |
| N-531 | Id | S9 | A6 |
| N-532 | Id | S9 | A7 |
| N-533 | Id | S9 | A8 |
| N-534 | Id | S9 | A9 |
| N-535 | Id | S9 | A10 |
| N-536 | Id | S9 | A11 |
| N-537 | Id | S9 | A12 |
| N-538 | Id | S9 | A13 |
| N-539 | Id | S9 | A14 |
| N-540 | Id | S9 | A15 |
| N-541 | Ie | S1 | A1 |
| N-542 | Ie | S1 | A2 |
| N-543 | Ie | S1 | A3 |
| N-544 | Ie | S1 | A4 |
| N-545 | Ie | S1 | A5 |
| N-546 | Ie | S1 | A6 |
| N-547 | Ie | S1 | A7 |
| N-548 | Ie | S1 | A8 |
| N-549 | Ie | S1 | A9 |
| N-550 | Ie | S1 | A10 |
| N-551 | Ie | S1 | A11 |
| N-552 | Ie | S1 | A12 |
| N-553 | Ie | S1 | A13 |
| N-554 | Ie | S1 | A14 |
| N-555 | Ie | S1 | A15 |
| N-556 | Ie | S2 | A1 |
| N-557 | Ie | S2 | A2 |
| N-558 | Ie | S2 | A3 |
| N-559 | Ie | S2 | A4 |
| N-560 | Ie | S2 | A5 |
| N-561 | Ie | S2 | A6 |
| N-562 | Ie | S2 | A7 |
| N-563 | Ie | S2 | A8 |
| N-564 | Ie | S2 | A9 |
| N-565 | Ie | S2 | A10 |
| N-566 | Ie | S2 | A11 |
| N-567 | Ie | S2 | A12 |
| N-568 | Ie | S2 | A13 |
| N-569 | Ie | S2 | A14 |
| N-570 | Ie | S2 | A15 |
| N-571 | Ie | S3 | A1 |
| N-572 | Ie | S3 | A2 |
| N-573 | Ie | S3 | A3 |
| N-574 | Ie | S3 | A4 |
| N-575 | Ie | S3 | A5 |
| N-576 | Ie | S3 | A6 |
| N-577 | Ie | S3 | A7 |
| N-578 | Ie | S3 | A8 |
| N-579 | Ie | S3 | A9 |
| N-580 | Ie | S3 | A10 |
| N-581 | Ie | S3 | A11 |
| N-582 | Ie | S3 | A12 |
| N-583 | Ie | S3 | A13 |
| N-584 | Ie | S3 | A14 |
| N-585 | Ie | S3 | A15 |
| N-586 | Ie | S4 | A1 |
| N-587 | Ie | S4 | A2 |
| N-588 | Ie | S4 | A3 |
| N-589 | Ie | S4 | A4 |
| N-590 | Ie | S4 | A5 |
| N-591 | Ie | S4 | A6 |
| N-592 | Ie | S4 | A7 |
| N-593 | Ie | S4 | A8 |
| N-594 | Ie | S4 | A9 |
| N-595 | Ie | S4 | A10 |
| N-596 | Ie | S4 | A11 |
| N-597 | Ie | S4 | A12 |
| N-598 | Ie | S4 | A13 |
| N-599 | Ie | S4 | A14 |
| N-600 | Ie | S4 | A15 |
| N-601 | Ie | S5 | A1 |
| N-602 | Ie | S5 | A2 |
| N-603 | Ie | S5 | A3 |
| N-604 | Ie | S5 | A4 |
| N-605 | Ie | S5 | A5 |
| N-606 | Ie | S5 | A6 |
| N-607 | Ie | S5 | A7 |
| N-608 | Ie | S5 | A8 |
| N-609 | Ie | S5 | A9 |
| N-610 | Ie | S5 | A10 |
| N-611 | Ie | S5 | A11 |
| N-612 | Ie | S5 | A12 |
| N-613 | Ie | S5 | A13 |
| N-614 | Ie | S5 | A14 |
| N-615 | Ie | S5 | A15 |
| N-616 | Ie | S6 | A1 |
| N-617 | Ie | S6 | A2 |
| N-618 | Ie | S6 | A3 |
| N-619 | Ie | S6 | A4 |
| N-620 | Ie | S6 | A5 |
| N-621 | Ie | S6 | A6 |
| N-622 | Ie | S6 | A7 |
| N-623 | Ie | S6 | A8 |
| N-624 | Ie | S6 | A9 |
| N-625 | Ie | S6 | A10 |
| N-626 | Ie | S6 | A11 |
| N-627 | Ie | S6 | A12 |
| N-628 | Ie | S6 | A13 |
| N-629 | Ie | S6 | A14 |
| N-630 | Ie | S6 | A15 |
| N-631 | Ie | S7 | A1 |
| N-632 | Ie | S7 | A2 |
| N-633 | Ie | S7 | A3 |
| N-634 | Ie | S7 | A4 |
| N-635 | Ie | S7 | A5 |
| N-636 | Ie | S7 | A6 |
| N-637 | Ie | S7 | A7 |
| N-638 | Ie | S7 | A8 |
| N-639 | Ie | S7 | A9 |
| N-640 | Ie | S7 | A10 |
| N-641 | Ie | S7 | A11 |
| N-642 | Ie | S7 | A12 |
| N-643 | Ie | S7 | A13 |
| N-644 | Ie | S7 | A14 |
| N-645 | Ie | S7 | A15 |
| N-646 | Ie | S8 | A1 |
| N-647 | Ie | S8 | A2 |
| N-648 | Ie | S8 | A3 |
| N-649 | Ie | S8 | A4 |
| N-650 | Ie | S8 | A5 |
| N-651 | Ie | S8 | A6 |
| N-652 | Ie | S8 | A7 |
| N-653 | Ie | S8 | A8 |
| N-654 | Ie | S8 | A9 |
| N-655 | Ie | S8 | A10 |
| N-656 | Ie | S8 | A11 |
| N-657 | Ie | S8 | A12 |
| N-658 | Ie | S8 | A13 |
| N-659 | Ie | S8 | A14 |
| N-660 | Ie | S8 | A15 |
| N-661 | Ie | S9 | A1 |
| N-662 | Ie | S9 | A2 |
| N-663 | Ie | S9 | A3 |
| N-664 | Ie | S9 | A4 |
| N-665 | Ie | S9 | A5 |
| N-666 | Ie | S9 | A6 |
| N-667 | Ie | S9 | A7 |
| N-668 | Ie | S9 | A8 |
| N-669 | Ie | S9 | A9 |
| N-670 | Ie | S9 | A10 |
| N-671 | Ie | S9 | A11 |
| N-672 | Ie | S9 | A12 |
| N-673 | Ie | S9 | A13 |
| N-674 | Ie | S9 | A14 |
| N-675 | Ie | S9 | A15 |
| N-676 | If | S1 | A1 |
| N-677 | If | S1 | A2 |
| N-678 | If | S1 | A3 |
| N-679 | If | S1 | A4 |
| N-680 | If | S1 | A5 |
| N-681 | If | S1 | A6 |
| N-682 | If | S1 | A7 |
| N-683 | If | S1 | A8 |
| N-684 | If | S1 | A9 |
| N-685 | If | S1 | A10 |
| N-686 | If | S1 | A11 |
| N-687 | If | S1 | A12 |
| N-688 | If | S1 | A13 |
| N-689 | If | S1 | A14 |
| N-690 | If | S1 | A15 |
| N-691 | If | S2 | A1 |
| N-692 | If | S2 | A2 |
| N-693 | If | S2 | A3 |
| N-694 | If | S2 | A4 |
| N-695 | If | S2 | A5 |
| N-696 | If | S2 | A6 |
| N-697 | If | S2 | A7 |
| N-698 | If | S2 | A8 |
| N-699 | If | S2 | A9 |
| N-700 | If | S2 | A10 |
| N-701 | If | S2 | A11 |
| N-702 | If | S2 | A12 |
| N-703 | If | S2 | A13 |
| N-704 | If | S2 | A14 |
| N-705 | If | S2 | A15 |
| N-706 | If | S3 | A1 |
| N-707 | If | S3 | A2 |
| N-708 | If | S3 | A3 |
| N-709 | If | S3 | A4 |
| N-710 | If | S3 | A5 |
| N-711 | If | S3 | A6 |
| N-712 | If | S3 | A7 |
| N-713 | If | S3 | A8 |
| N-714 | If | S3 | A9 |
| N-715 | If | S3 | A10 |
| N-716 | If | S3 | A11 |
| N-717 | If | S3 | A12 |
| N-718 | If | S3 | A13 |
| N-719 | If | S3 | A14 |
| N-720 | If | S3 | A15 |
| N-721 | If | S4 | A1 |
| N-722 | If | S4 | A2 |
| N-723 | If | S4 | A3 |
| N-724 | If | S4 | A4 |
| N-725 | If | S4 | A5 |
| N-726 | If | S4 | A6 |
| N-727 | If | S4 | A7 |
| N-728 | If | S4 | A8 |
| N-729 | If | S4 | A9 |
| N-730 | If | S4 | A10 |
| N-731 | If | S4 | A11 |
| N-732 | If | S4 | A12 |
| N-733 | If | S4 | A13 |
| N-734 | If | S4 | A14 |
| N-735 | If | S4 | A15 |
| N-736 | If | S5 | A1 |
| N-737 | If | S5 | A2 |
| N-738 | If | S5 | A3 |
| N-739 | If | S5 | A4 |
| N-740 | If | S5 | A5 |
| N-741 | If | S5 | A6 |
| N-742 | If | S5 | A7 |
| N-743 | If | S5 | A8 |
| N-744 | If | S5 | A9 |
| N-745 | If | S5 | A10 |
| N-746 | If | S5 | A11 |
| N-747 | If | S5 | A12 |
| N-748 | If | S5 | A13 |
| N-749 | If | S5 | A14 |
| N-750 | If | S5 | A15 |
| N-751 | If | S6 | A1 |
| N-752 | If | S6 | A2 |
| N-753 | If | S6 | A3 |
| N-754 | If | S6 | A4 |
| N-755 | If | S6 | A5 |
| N-756 | If | S6 | A6 |
| N-757 | If | S6 | A7 |
| N-758 | If | S6 | A8 |
| N-759 | If | S6 | A9 |
| N-760 | If | S6 | A10 |
| N-761 | If | S6 | A11 |
| N-762 | If | S6 | A12 |
| N-763 | If | S6 | A13 |
| N-764 | If | S6 | A14 |
| N-765 | If | S6 | A15 |
| N-766 | If | S7 | A1 |
| N-767 | If | S7 | A2 |
| N-768 | If | S7 | A3 |
| N-769 | If | S7 | A4 |
| N-770 | If | S7 | A5 |
| N-771 | If | S7 | A6 |
| N-772 | If | S7 | A7 |
| N-773 | If | S7 | A8 |
| N-774 | If | S7 | A9 |
| N-775 | If | S7 | A10 |
| N-776 | If | S7 | A11 |
| N-777 | If | S7 | A12 |
| N-778 | If | S7 | A13 |
| N-779 | If | S7 | A14 |
| N-780 | If | S7 | A15 |
| N-781 | If | S8 | A1 |
| N-782 | If | S8 | A2 |
| N-783 | If | S8 | A3 |
| N-784 | If | S8 | A4 |
| N-785 | If | S8 | A5 |
| N-786 | If | S8 | A6 |
| N-787 | If | S8 | A7 |
| N-788 | If | S8 | A8 |
| N-789 | If | S8 | A9 |
| N-790 | If | S8 | A10 |
| N-791 | If | S8 | A11 |
| N-792 | If | S8 | A12 |
| N-793 | If | S8 | A13 |
| N-794 | If | S8 | A14 |
| N-795 | If | S8 | A15 |
| N-796 | If | S9 | A1 |
| N-797 | If | S9 | A2 |
| N-798 | If | S9 | A3 |
| N-799 | If | S9 | A4 |
| N-800 | If | S9 | A5 |
| N-801 | If | S9 | A6 |
| N-802 | If | S9 | A7 |
| N-803 | If | S9 | A8 |
| N-804 | If | S9 | A9 |
| N-805 | If | S9 | A10 |
| N-806 | If | S9 | A11 |
| N-807 | If | S9 | A12 |
| N-808 | If | S9 | A13 |
| N-809 | If | S9 | A14 |
| N-810 | If | S9 | A15 |
| N-811 | Ig | S1 | A1 |
| N-812 | Ig | S1 | A2 |
| N-813 | Ig | S1 | A3 |
| N-814 | Ig | S1 | A4 |
| N-815 | Ig | S1 | A5 |
| N-816 | Ig | S1 | A6 |
| N-817 | Ig | S1 | A7 |
| N-818 | Ig | S1 | A8 |
| N-819 | Ig | S1 | A9 |
| N-820 | Ig | S1 | A10 |
| N-821 | Ig | S1 | A11 |
| N-822 | Ig | S1 | A12 |
| N-823 | Ig | S1 | A13 |
| N-824 | Ig | S1 | A14 |
| N-825 | Ig | S1 | A15 |
| N-826 | Ig | S2 | A1 |
| N-827 | Ig | S2 | A2 |
| N-828 | Ig | S2 | A3 |
| N-829 | Ig | S2 | A4 |
| N-830 | Ig | S2 | A5 |
| N-831 | Ig | S2 | A6 |
| N-832 | Ig | S2 | A7 |
| N-833 | Ig | S2 | A8 |
| N-834 | Ig | S2 | A9 |
| N-835 | Ig | S2 | A10 |
| N-836 | Ig | S2 | A11 |
| N-837 | Ig | S2 | A12 |
| N-838 | Ig | S2 | A13 |
| N-839 | Ig | S2 | A14 |
| N-840 | Ig | S2 | A15 |
| N-841 | Ig | S3 | A1 |
| N-842 | Ig | S3 | A2 |
| N-843 | Ig | S3 | A3 |
| N-844 | Ig | S3 | A4 |
| N-845 | Ig | S3 | A5 |
| N-846 | Ig | S3 | A6 |
| N-847 | Ig | S3 | A7 |
| N-848 | Ig | S3 | A8 |
| N-849 | Ig | S3 | A9 |
| N-850 | Ig | S3 | A10 |
| N-851 | Ig | S3 | A11 |
| N-852 | Ig | S3 | A12 |
| N-853 | Ig | S3 | A13 |
| N-854 | Ig | S3 | A14 |
| N-855 | Ig | S3 | A15 |
| N-856 | Ig | S4 | A1 |
| N-857 | Ig | S4 | A2 |
| N-858 | Ig | S4 | A3 |
| N-859 | Ig | S4 | A4 |
| N-860 | Ig | S4 | A5 |
| N-861 | Ig | S4 | A6 |
| N-862 | Ig | S4 | A7 |
| N-863 | Ig | S4 | A8 |
| N-864 | Ig | S4 | A9 |
| N-865 | Ig | S4 | A10 |
| N-866 | Ig | S4 | A11 |
| N-867 | Ig | S4 | A12 |
| N-868 | Ig | S4 | A13 |
| N-869 | Ig | S4 | A14 |
| N-870 | Ig | S4 | A15 |
| N-871 | Ig | S5 | A1 |
| N-872 | Ig | S5 | A2 |
| N-873 | Ig | S5 | A3 |
| N-874 | Ig | S5 | A4 |
| N-875 | Ig | S5 | A5 |
| N-876 | Ig | S5 | A6 |
| N-877 | Ig | S5 | A7 |
| N-878 | Ig | S5 | A8 |
| N-879 | Ig | S5 | A9 |
| N-880 | Ig | S5 | A10 |
| N-881 | Ig | S5 | A11 |
| N-882 | Ig | S5 | A12 |
| N-883 | Ig | S5 | A13 |
| N-884 | Ig | S5 | A14 |
| N-885 | Ig | S5 | A15 |
| N-886 | Ig | S6 | A1 |
| N-887 | Ig | S6 | A2 |
| N-888 | Ig | S6 | A3 |
| N-889 | Ig | S6 | A4 |
| N-890 | Ig | S6 | A5 |
| N-891 | Ig | S6 | A6 |
| N-892 | Ig | S6 | A7 |
| N-893 | Ig | S6 | A8 |
| N-894 | Ig | S6 | A9 |
| N-895 | Ig | S6 | A10 |
| N-896 | Ig | S6 | A11 |
| N-897 | Ig | S6 | A12 |
| N-898 | Ig | S6 | A13 |
| N-899 | Ig | S6 | A14 |
| N-900 | Ig | S6 | A15 |
| N-901 | Ig | S7 | A1 |
| N-902 | Ig | S7 | A2 |
| N-903 | Ig | S7 | A3 |
| N-904 | Ig | S7 | A4 |
| N-905 | Ig | S7 | A5 |
| N-906 | Ig | S7 | A6 |
| N-907 | Ig | S7 | A7 |
| N-908 | Ig | S7 | A8 |
| N-909 | Ig | S7 | A9 |
| N-910 | Ig | S7 | A10 |
| N-911 | Ig | S7 | A11 |
| N-912 | Ig | S7 | A12 |
| N-913 | Ig | S7 | A13 |
| N-914 | Ig | S7 | A14 |
| N-915 | Ig | S7 | A15 |
| N-916 | Ig | S8 | A1 |
| N-917 | Ig | S8 | A2 |
| N-918 | Ig | S8 | A3 |
| N-919 | Ig | S8 | A4 |
| N-920 | Ig | S8 | A5 |
| N-921 | Ig | S8 | A6 |
| N-922 | Ig | S8 | A7 |
| N-923 | Ig | S8 | A8 |
| N-924 | Ig | S8 | A9 |
| N-925 | Ig | S8 | A10 |
| N-926 | Ig | S8 | A11 |
| N-927 | Ig | S8 | A12 |
| N-928 | Ig | S8 | A13 |
| N-929 | Ig | S8 | A14 |
| N-930 | Ig | S8 | A15 |
| N-931 | Ig | S9 | A1 |
| N-932 | Ig | S9 | A2 |
| N-933 | Ig | S9 | A3 |
| N-934 | Ig | S9 | A4 |
| N-935 | Ig | S9 | A5 |
| N-936 | Ig | S9 | A6 |
| N-937 | Ig | S9 | A7 |
| N-938 | Ig | S9 | A8 |
| N-939 | Ig | S9 | A9 |
| N-940 | Ig | S9 | A10 |
| N-941 | Ig | S9 | A11 |
| N-942 | Ig | S9 | A12 |
| N-943 | Ig | S9 | A13 |
| N-944 | Ig | S9 | A14 |
| N-945 | Ig | S9 | A15 |
| N-946 | Ia | Fip | H1 |
| N-947 | Ia | Ethi | H1 |
| N-948 | Ib | Fip | H1 |
| N-949 | Ib | Ethi | H1 |
| N-950 | Ic | Fip | H1 |
| N-951 | Ic | Ethi | H1 |
| N-952 | Id | Fip | H1 |
| N-953 | Id | Ethi | H1 |
| N-954 | Ie | Fip | H1 |
| N-955 | Ie | Ethi | H1 |
| N-956 | If | Fip | H1 |
| N-957 | If | Ethi | H1 |
| N-958 | Ig | Fip | H1 |
| N-959 | Ig | Ethi | H1 |
| N-960 | Ia | A1 | H1 |
| N-961 | Ia | A2 | H1 |
| N-962 | Ia | A3 | H1 |
| N-963 | Ia | A4 | H1 |
| N-964 | Ia | A5 | H1 |
| N-965 | Ia | A6 | H1 |
| N-966 | Ia | A7 | H1 |
| N-967 | Ia | A8 | H1 |
| N-968 | Ia | A9 | H1 |
| N-969 | Ia | A10 | H1 |
| N-970 | Ia | A11 | H1 |
| N-971 | Ia | A12 | H1 |
| N-972 | Ia | A13 | H1 |
| N-973 | Ia | A14 | H1 |
| N-974 | Ia | A15 | H1 |
| N-975 | Ib | A1 | H1 |
| N-976 | Ib | A2 | H1 |
| N-977 | Ib | A3 | H1 |
| N-978 | Ib | A4 | H1 |
| N-979 | Ib | A5 | H1 |
| N-980 | Ib | A6 | H1 |
| N-981 | Ib | A7 | H1 |
| N-982 | Ib | A8 | H1 |
| N-983 | Ib | A9 | H1 |
| N-984 | Ib | A10 | H1 |
| N-985 | Ib | A11 | H1 |
| N-986 | Ib | A12 | H1 |
| N-987 | Ib | A13 | H1 |
| N-988 | Ib | A14 | H1 |
| N-989 | Ib | A15 | H1 |
| N-990 | Ic | A1 | H1 |
| N-991 | Ic | A2 | H1 |
| N-992 | Ic | A3 | H1 |
| N-993 | Ic | A4 | H1 |
| N-994 | Ic | A5 | H1 |
| N-995 | Ic | A6 | H1 |
| N-996 | Ic | A7 | H1 |
| N-997 | Ic | A8 | H1 |
| N-998 | Ic | A9 | H1 |
| N-999 | Ic | A10 | H1 |
| N-1000 | Ic | A11 | H1 |
| N-1001 | Ic | A12 | H1 |
| N-1002 | Ic | A13 | H1 |
| N-1003 | Ic | A14 | H1 |
| N-1004 | Ic | A15 | H1 |
| N-1005 | Id | A1 | H1 |
| N-1006 | Id | A2 | H1 |
| N-1007 | Id | A3 | H1 |
| N-1008 | Id | A4 | H1 |
| N-1009 | Id | A5 | H1 |
| N-1010 | Id | A6 | H1 |
| N-1011 | Id | A7 | H1 |
| N-1012 | Id | A8 | H1 |
| N-1013 | Id | A9 | H1 |
| N-1014 | Id | A10 | H1 |
| N-1015 | Id | A11 | H1 |
| N-1016 | Id | A12 | H1 |
| N-1017 | Id | A13 | H1 |
| N-1018 | Id | A14 | H1 |
| N-1019 | Id | A15 | H1 |
| N-1020 | Ie | A1 | H1 |
| N-1021 | Ie | A2 | H1 |
| N-1022 | Ie | A3 | H1 |
| N-1023 | Ie | A4 | H1 |
| N-1024 | Ie | A5 | H1 |
| N-1025 | Ie | A6 | H1 |
| N-1026 | Ie | A7 | H1 |
| N-1027 | Ie | A8 | H1 |
| N-1028 | Ie | A9 | H1 |
| N-1029 | Ie | A10 | H1 |
| N-1030 | Ie | A11 | H1 |
| N-1031 | Ie | A12 | H1 |
| N-1032 | Ie | A13 | H1 |
| N-1033 | Ie | A14 | H1 |
| N-1034 | Ie | A15 | H1 |
| N-1035 | If | A1 | H1 |
| N-1036 | If | A2 | H1 |
| N-1037 | If | A3 | H1 |
| N-1038 | If | A4 | H1 |
| N-1039 | If | A5 | H1 |
| N-1040 | If | A6 | H1 |
| N-1041 | If | A7 | H1 |
| N-1042 | If | A8 | H1 |
| N-1043 | If | A9 | H1 |
| N-1044 | If | A10 | H1 |
| N-1045 | If | A11 | H1 |
| N-1046 | If | A12 | H1 |
| N-1047 | If | A13 | H1 |
| N-1048 | If | A14 | H1 |
| N-1049 | If | A15 | H1 |
| N-1050 | Ig | A1 | H1 |
| N-1051 | Ig | A2 | H1 |
| N-1052 | Ig | A3 | H1 |
| N-1053 | Ig | A4 | H1 |
| N-1054 | Ig | A5 | H1 |
| N-1055 | Ig | A6 | H1 |
| N-1056 | Ig | A7 | H1 |
| N-1057 | Ig | A8 | H1 |
| N-1058 | Ig | A9 | H1 |
| N-1059 | Ig | A10 | H1 |
| N-1060 | Ig | A11 | H1 |
| N-1061 | Ig | A12 | H1 |
| N-1062 | Ig | A13 | H1 |
| N-1063 | Ig | A14 | H1 |
| N-1064 | Ig | A15 | H1 |
| N-1065 | Ia | S1 | H1 |
| N-1066 | Ia | S2 | H1 |
| N-1067 | Ia | S3 | H1 |
| N-1068 | Ia | S4 | H1 |
| N-1069 | Ia | S5 | H1 |
| N-1070 | Ia | S6 | H1 |
| N-1071 | Ia | S7 | H1 |
| N-1072 | Ia | S8 | H1 |
| N-1073 | Ia | S9 | H1 |
| N-1074 | Ib | S1 | H1 |
| N-1075 | Ib | S2 | H1 |
| N-1076 | Ib | S3 | H1 |
| N-1077 | Ib | S4 | H1 |
| N-1078 | Ib | S5 | H1 |
| N-1079 | Ib | S6 | H1 |
| N-1080 | Ib | S7 | H1 |
| N-1081 | Ib | S8 | H1 |
| N-1082 | Ib | S9 | H1 |
| N-1083 | Ic | S1 | H1 |
| N-1084 | Ic | S2 | H1 |
| N-1085 | Ic | S3 | H1 |
| N-1086 | Ic | S4 | H1 |
| N-1087 | Ic | S5 | H1 |
| N-1088 | Ic | S6 | H1 |
| N-1089 | Ic | S7 | H1 |
| N-1090 | Ic | S8 | H1 |
| N-1091 | Ic | S9 | H1 |
| N-1092 | Id | S1 | H1 |
| N-1093 | Id | S2 | H1 |
| N-1094 | Id | S3 | H1 |
| N-1095 | Id | S4 | H1 |
| N-1096 | Id | S5 | H1 |
| N-1097 | Id | S6 | H1 |
| N-1098 | Id | S7 | H1 |
| N-1099 | Id | S8 | H1 |
| N-1100 | Id | S9 | H1 |
| N-1101 | Ie | S1 | H1 |
| N-1102 | Ie | S2 | H1 |
| N-1103 | Ie | S3 | H1 |
| N-1104 | Ie | S4 | H1 |
| N-1105 | Ie | S5 | H1 |
| N-1106 | Ie | S6 | H1 |
| N-1107 | Ie | S7 | H1 |
| N-1108 | Ie | S8 | H1 |
| N-1109 | Ie | S9 | H1 |
| N-1110 | If | S1 | H1 |
| N-1111 | If | S2 | H1 |
| N-1112 | If | S3 | H1 |
| N-1113 | If | S4 | H1 |
| N-1114 | If | S5 | H1 |
| N-1115 | If | S6 | H1 |
| N-1116 | If | S7 | H1 |
| N-1117 | If | S8 | H1 |
| N-1118 | If | S9 | H1 |
| N-1119 | Ig | S1 | H1 |
| N-1120 | Ig | S2 | H1 |
| N-1121 | Ig | S3 | H1 |
| N-1122 | Ig | S4 | H1 |
| N-1123 | Ig | S5 | H1 |
| N-1124 | Ig | S6 | H1 |
| N-1125 | Ig | S7 | H1 |
| N-1126 | Ig | S8 | H1 |
| N-1127 | Ig | S9 | H1 |

Within the ternary mixtures of table 2, the following mixtures are especially preferred according to the present invention:

N-1, N-2, N-3, N-4, N-5, N-6, N-7, N-8, N-9, N-10, N-11, N-12, N-13, N-14, N-15, N-16, N-17, N-18, N-19, N-20, N-21, N-22, N-23, N-24, N-25, N-26, N-27, N-28, N-29, N-30, N-31, N-32, N-33, N-34, N-35, N-36, N-37, N-38, N-39, N-40, N-41, N-42, N-43, N-44, N-45, N-46, N-47, N-48, N-49, N-50, N-51, N-52, N-53, N-54, N-55, N-56, N-57, N-58, N-59, N-60, N-61, N-62, N-63, N-64, N-65, N-66, N-67, N-68, N-69, N-70, N-71, N-72, N-73, N-74, N-75, N-76, N-77, N-78, N-79, N-80, N-81, N-82, N-83, N-84, N-85, N-86, N-87, N-88, N-89, N-90, N-91, N-92, N-93, N-94, N-95, N-96, N-97, N-98, N-99, N-100, N-101, N-102, N-103, N-104, N-105, N-106, N-107, N-108, N-109, N-110, N-111, N-112, N-113, N-114, N-115, N-116, N-117, N-118, N-119, N-120, N-121, N-122, N-123, N-124, N-125, N-126, N-127, N-128, N-129, N-130, N-131, N-132, N-133, N-134, N-135, N-960, N-961, N-962, N-963, N-964, N-965, N-966, N-967, N-968, N-969, N-970, N-971, N-972, N-973, N-974, N-1065, N-1066, N-1067, N-1068, N-1069, N-1070, N-1071, N-1072, N-1073, N-1083, N-1084, N-1085, N-1086, N-1087, N-1088, N-1089, N-1090, N-1091, N-1110, N-1111, N-1112, N-1113, N-1114, N-1115, N-1116, N-1117, N-1118, N-1119, N-1120, N-1121, N-1122, N-1123, N-1124, N-1125, N-1126 and N-1127.

Within the mixtures of table 2, the mixture N-78, which comprises the amide compound of the formula Ia, orysastrobin (S6) as a further fungicide II and epoxiconazole (A3) as a further fungicide III, is of utmost preference.

Within the mixtures of table 2, the mixture N-108, which comprises the amide compound of the formula Ia, pyraclostrobin (S8) as a further fungicide II and epoxiconazole (A3) as a further fungicide III, is of utmost preference.

Within the mixtures of table 2, the mixture N-962, which comprises the amide compound of the formula Ia, epoxiconazole (A3) as a further fungicide II and glyphosate (H1), is of utmost preference.

Within the mixtures of table 2, the mixture N-1070, which comprises the amide compound of the formula Ia, orysastrobin (S6) as a further fungicide II and glyphosate (H1), is of utmost preference.

Within the mixtures of table 2, the mixture N-1072, which comprises the amide compound of the formula Ia, pyraclostrobin (S8) as a further fungicide II and glyphosate (H1), is of utmost preference.

Within the mixtures of table 2, the mixture N-1088, which comprises the amide compound of the formula Ic (bixafen), orysastrobin (S6) as a further fungicide II and glyphosate (H1), is of utmost preference.

Within the mixtures of table 2, the mixture N-1090, which comprises the amide compound of the formula Ic (bixafen), pyraclostrobin (S8) as a further fungicide II and glyphosate (H1), is of utmost preference.

Within the mixtures of table 2, the mixture N-1115, which comprises the amide compound of the formula If (isopyrazam), orysastrobin (S6) as a further fungicide II and glyphosate (H1), is of utmost preference.

Within the mixtures of table 2, the mixture N-1117, which comprises the amide compound of the formula If (isopyrazam), pyraclostrobin (S8) as a further fungicide II and glyphosate (H1), is of utmost preference.

Within the mixtures of table 2, the mixture N-1124, which comprises the amide compound of the formula Ig (penthiopyrad), orysastrobin (S6) as a further fungicide II and glyphosate (H1), is of utmost preference.

Within the mixtures of table 2, the mixture N-1126, which comprises the amide compound of the formula Ig (penthiopyrad), pyraclostrobin (S8) as a further fungicide II and glyphosate (H1), is of utmost preference.

With respect to their intended use within the methods of the present invention, the following quaternary mixtures of a strobilurin compound (2)(i) in combination with mixtures listed in table 2 above are a preffered embodiment of the present invention:

A quaternary mixture (Q-1 to Q-105) comprising the strobilurin compound S1 and a ternary mixture, wherin the ternary mixture in each case corresponds to a row of table 2 selected from the mixtures No. N-960 to N-1064.

A quaternary mixture (Q-106 to Q-210) comprising the strobilurin compound S2 and a ternary mixture, wherin the ternary mixture in each case corresponds to a row of table 2 selected from the mixtures No. N-960 to N-1064.

A quaternary mixture (Q-211 to Q-315) comprising the strobilurin compound S3 and a ternary mixture, wherin the ternary mixture in each case corresponds to a row of table 2 selected from the mixtures No. N-960 to N-1064.

A quaternary mixture (Q-316 to Q-420) comprising the strobilurin compound S4 and a ternary mixture, wherin the ternary mixture in each case corresponds to a row of table 2 selected from the mixtures No. N-960 to N-1064.

A quaternary mixture (Q-421 to Q-525) comprising the strobilurin compound S5 and a ternary mixture, wherin the ternary mixture in each case corresponds to a row of table 2 selected from the mixtures No. N-960 to N-1064.

A quaternary mixture (Q-526 to Q-630) comprising the strobilurin compound S6 and a ternary mixture, wherin the ternary mixture in each case corresponds to a row of table 2 selected from the mixtures No. N-960 to N-1064.

A quaternary mixture (Q-631 to Q-735) comprising the strobilurin compound S7 and a ternary mixture, wherin the ternary mixture in each case corresponds to a row of table 2 selected from the mixtures No. N-960 to N-1064.

A quaternary mixture (Q-736 to Q-840) comprising the strobilurin compound S8 and a ternary mixture, wherin the ternary mixture in each case corresponds to a row of table 2 selected from the mixtures No. N-960 to N-1064.

A quaternary mixture (Q-841 to Q-945) comprising the strobilurin compound S9 and a ternary mixture, wherin the ternary mixture in each case corresponds to a row of table 2 selected from the mixtures No. N-960 to N-1064.

Within the quaterny mixtures disclosed above, the mixture comprising the amide compound of the formula Ia, pyraclostrobin (S8) as a further fungicide II, epoxiconazole (A3) as a further fungicide III and additionally glyphosate (H1), is of utmost preference.

Within the quaterny mixtures disclosed above, the mixture comprsing the amide compound of the formula (Ia), orysastrobin (S6) as a further fungicide II, epoxiconazole (A3) as a further fungicide III and additionally glyphosate (H1), is of utmost preference.

In all mixtures used according to the methods of the present invention, compounds (I) and compounds (II), (IIb), (III) or (IV), are employed in amounts to afford a synergistic effect. The weight ratio of compound (I) to compounds (II), (IIb), (III) or (IV), is preferably from 200:1 to 1:200, more preferably from 100:1 to 1:100, more preferably from 50:1 to 1:50 and in particular from 20:1 to 1:20. The utmost preferred ratio is 1:10 to 10:1. The weight ratio refers to the total weight of compounds (I) and compounds (II), (IIb), (III) or (IV), in the mixture.

All mixtures set forth above are also an embodiment of the present invention.

All embodiments of the mixtures set forth above are herein below referred to as “mixtures according to the present invention”.

As mentioned above, the compounds (I) or the mixtures according to the present invention are used for improving the health of plants when applied to plant or parts of plants or to their actual or intended locus of growth.

Thus, the invention also relates to a method for improving the health of plants, which comprises treating the plant, a part of the plant, the locus where the plant is growing or is expected to grow with the compounds (I) or the mixtures according to the present invention.

If a mixture according to the present invention is used in this inventive method, the plant and/or the locus where the plant is growing or is expected to grow are preferably treated simultaneously (together or separately) or subsequently with the the amide compound of the formula I (compound I) and at least one further compound selected from the group consisting of compounds (II), (IIb), (III) and (IV).

Of course, the subsequent application is carried out with a time interval which allows a combined action of the applied compounds. Preferably, the time interval for a subsequent application of compound (I) and compounds (II), (IIb), (III) and/or (IV), ranges from a few seconds up to 3 months, preferably, from a few seconds up to 1 month, more preferably from a few seconds up to 2 weeks, even more preferably from a few seconds up to 3 days and in particular from 1 second up to 24 hours.

The term “BBCH principal growth stage” refers to the extended BBCH-scale which is a system for a uniform coding of phenologically similar growth stages of all mono- and dicotyldedonous plant species in which the entire developmental cycle of the plants is subdivided into clearly recoginizable and distinguishable longer-lasting developmental phases. The abbreviation BBCH dervies from Biologische Bundesanstalt, Bundessor-tenamt and CHemical industry.

“Locus” means soil, area, material or environment where the plant is growing or intended to grow.

As a matter of course, compounds (I) and in case mixtures are employed, compounds selected from the group consisting of compounds (II), (IIb), (III) and (IV), are used in an effective and non-phytotoxic amount. This means that they are used in a quantity which allows to obtain the desired effect but which does not give rise to any phytotoxic symptom on the treated plant or on the plant raised from the treated propagule or treated soil.

The plants to be treated are generally plants of economic importance and/or mengrown plants. Thus, they are preferably selected from agricultural, silvicultural and ornamental plants, more preferably from agricultural plants.

Generally the term “plants” also includes plants which have been modified by breeding, mutagenesis or genetic engineering. Genetically modified plants are plants, which genetic material has been modified by the use of recombinant DNA techniques. The use of recombinant DNA techniques makes modification possible that cannot readily be obtained by cross breeding under natural circumstances, mutations or natural recombination.

Thus, also the preferred soybeans mentioned herein can be a non-transgenic plant, e.g. as obtained by traditional breeding, or can have at least one transgenic event. In one embodiment it is preferred that the soybean plant be a transgenic plant having preferably a transgenic event that confers resistance to a pesticide, preferably against the herbicide glyphosate. Accordingly, it is preferred that the transgenic plant be one having a transgenic event that provides glyphosate resistance. Some examples of such preferred transgenic plants having transgenic events that confer glyphosate resistance are described in U.S. Pat. No. 5,914,451, U.S. Pat. No. 5,866,775, U.S. Pat. No. 5,804,425, U.S. Pat. No. 5,776,760, U.S. Pat. No. 5,633,435, U.S. Pat. No. 5,627,061, U.S. Pat. No. 5,463,175, U.S. Pat. No. 5,312,910, U.S. Pat. No. 5,310,667, U.S. Pat. No. 5,188,642, U.S. Pat. No. 5,145,783, U.S. Pat. No. 4,971,908 and U.S. Pat. No. 4,940,835. More preferably, the transgenic soybean plant has the characteristics of “Roundup-Ready” (RR) transgenic soybeans (available from Monsanto Company, St. Louis, Mo.).

“Silvicultural plants” in the terms of the present invention are trees, more specifically trees used in reforestation or industrial plantations. Industrial plantations generally serve for the commercial production of forest products, such as wood, pulp, paper, rubber, Christmas trees, or young trees for gardening purposes. Examples for silvicultural plants are conifers, like pines, in particular Pinus spec., fir and spruce, eucalyptus, tropical trees like teak, rubber tree, oil palm, willow (Salix), in particular Salix spec., poplar (cottonwood), in particular Populus spec., beech, in particular Fagus spec., birch and oak.

In another embodiment of the invention, the plant health of which is to be improved by the treatment with the composition of the invention is an ornamental plant. “Ornamental plants” are plants which are commonly used in gardening, e.g. in parks, gardens and on balconies. Examples are turf, geranium, pelargonia, petunia, begonia, and fuchsia, to name just a few among the vast number of ornamentals.

“Agricultural plants” are plants of which a part (such as seeds) or allis harvested or cultivated on a commercial scale or which serve as an important source of feed, food, fibers (e.g. cotton, linen), combustibles (e.g. wood, bioethanol, biodiesel, biomass) or other chemical compounds. Agricultural plants may also include horticultural plants, i.e. plants grown in gardens (and not on fields), such as certain fruits and vegetables. Preferred agricultural plants are for example cereals, e. g. wheat, rye, barley, triticale, oats, sorghum or rice, beet, e. g. sugar beet or fodder beet; fruits, such as pomes, stone fruits or soft fruits, e. g. apples, pears, plums, peaches, almonds, cherries, strawberries, raspberries, blackberries or gooseberries; leguminous plants, such as lentils, peas, alfalfa or soybeans; oil plants, such as rape, oil-seed rape, canola, linseed, mustard, olives, sunflowers, coconut, cocoa beans, castor oil plants, oil palms, ground nuts or soybeans; cucurbits, such as squashes, cucumber or melons; fiber plants, such as cotton, flax, hemp or jute; citrus fruit, such as oranges, lemons, grapefruits or mandarins; vegetables, such as spinach, lettuce, asparagus, cabbages, carrots, onions, tomatoes, potatoes, cucurbits or paprika; lauraceous plants, such as avocados, cinnamon or camphor; energy and raw material plants, such as corn, soybean, rape, canola, sugar cane or oil palm; corn; tobacco; nuts; coffee; tea; bananas; vines (table grapes and grape juice grape vines); hop; turf; natural rubber plants or ornamental and forestry plants, such as flowers, shrubs, broad-leaved trees or evergreens, e. g. conifers.

In one embodiment of the present invention, fruit crops are preferred. Within fruit crops, apples, strawberries and citrus (e.g. orange and lemon) are especially preferred.

More preferred agricultural plants are field crops, such as potatoes, sugar beets, cereals such as wheat, rye, barley, oats, sorghum, rice, corn, cotton, rape, oilseed rape and canola, legumes such as soybeans, peas and field beans, sunflowers, sugar cane; ornamentals; or vegetables, such as cucumbers, tomatoes, or onions, leeks, lettuce, squashes, most preferred agricultural plants are potatoes, sugar beets, cereals such as wheat, rye, barley, oats, sorghum, rice, corn, cotton, soybeans, oilseed rape, canola, sunflower and utmost preferred plant is soybean.

In a preferred embodiment, the aforementioned method for improving the health of a plant comprises treating an agricultural plant and/or the locus where the plant is growing or is expected to grow with a compound (I) or a mixture according to the invention, wherein the agricultural plant is selected from the group consisting of transgenic or non-transgenic potatoes, sugar beets, cereals such as wheat, rye, barley, oats, sorghum, rice, corn, cotton, soybeans, oilseed rape, canola, sunflower with a composition of the invention, wherein soybean is utmost preferred. Such plants can be transgenic or non-transgenic plants.

If mixtures according to the present invention are used, the plant, the locus where the plant is growing or is expected to grow are preferably treated simultaneously (together or separately) or subsequently with the components present in the mixtures of the present invention.

“Plant health” is intended to mean a condition of the plant which is determined by several aspects alone or in combination with each other.

One indicator (indicator 1) for the condition of the plant is the yield, which is crop and/or fruit yield. “Crop” and “fruit” are to be understood as any plant product which is further utilized after harvesting, e.g. fruits in the proper sense, vegetables, nuts, grains, seeds, wood (e.g. in the case of silviculture plants), flowers (e.g. in the case of gardening plants, ornamentals) etc., that is anything of economic value that is produced by the plant. One way of tetermining the yield is the Thousand Grain Weight (TGW) of the harvested grains.

In one embodiment of the present invention, the plant yield becomes manifest by an increase in Thousand Grain Weight (TGW), straw yield, grain yield, tillering, harvest index and the single ear grain yield.

Another indicator (indicator 2) for the condition of the plant is the plant vigour. The plant vigour becomes manifest in several aspects, too, some of which are visual appearance, e.g. leaf color, fruit color and aspect, amount of dead basal leaves and/or extent of leaf blades, plant weight, plant height, extent of plant verse (lodging), number, strongness and productivity of tillers or branches or halms, panicles' length, seed set, extent of root system, strongness of roots, extent of nodulation, in particular of rhizobial nodulation, point of time of germination, emergence, flowering, grain maturity and/or senescence, protein content, sugar content and the like.

In one embodiment of the present invention, the plant vigour becomes manifest by an increase in plant height, number of halms with ear, tillering, plant shoot growth, number of grains per ear and the grean leaf area.

Another indicator (indicator 3) for the condition of the plant is the plant's tolerance or resistance to abiotic stress factors. Abiotic stress, especially over longer terms, can have harmful effects on plants. Abiotic stress is caused for example by extremes in temperature such as heat or cold or strong variations in temperature or temperatures unusual for the specific season, drought, extreme wetness like flooding or waterlogging, anaerobic conditions, high salinity, radiation (e.g. increased UV radiation due to the decreasing ozone protective layer), increased ozone levels and organic pollution (e.g. by phythotoxic amounts of pesticides) or inorganic pollution (e.g. by heavy metal contaminants). As a result, the quantity and the quality of the stressed plants, their crops and fruits decrease. As far as quality is concerned, reproductive development is usually severely affected with consequences on the crops which are important for fruits or seeds. Synthesis, accumulation and storage of proteins are mostly affected by temperature; growth is slowed by almost all stresses; polysaccharide synthesis, both structural and storage is reduced or modified: these effects bring to a decrease in biomass and to changes in the nutritional value of the product.

In one embodiment of the present invention, the tolerance of a plant against drought stress (abiotic stress) becomes manifest by an increase of water use effiency and a reduction of the plant's transpiration.

In one preferred embodiment, the present invention provides the use of the compound (I) of formula I or a mixture according to the present invention for increasing the yield of a plant, preferably of an agricultural, silvicultural and/or ornamental plant, more preferably of an agricultural plant.

The present invention further provides a method for increasing the yield of a plant, preferably of an agricultural, silvicultural and/or ornamental plant, more preferably of an agricultural plant.

In a more preferred embodiment, the aforementioned method for increasing the yield of the plant comprises treating the plant and/or the locus where the plant is growing or is expected to grow with a compound (I) or a mixture according to the present invention, wherein the plant is preferably selected from the group consisting of field crops, such as potatoes, sugar beets, cereals such as wheat, rye, barley, oats, sorghum, rice, corn, cotton, rape, oilseed rape and canola, legumes such as soybeans, peas and field beans, sunflowers, sugar cane; ornamentals; or vegetables, such as cucumbers, tomatoes, or onions, leeks, lettuce, squashes, more preferably agricultural plants are potatoes, sugar beets, cereals such as wheat, rye, barley, oats, sorghum, rice, corn, cotton, soybeans, oilseed rape, canola, sunflower.

In a especially preferred embodiment. the aforementioned method for increasing the plant health of the plant comprises treating the plant and/or the locus where the plant is growing or is expected to grow with a compound (I) or a mixture according to the present invention, wherein the plant is wheat, maize (corn) and soybeans.

In a particular preferred embodiment, the aforementioned method for increasing the yield of the plant comprises treating the plant and/or the locus where the plant is growing or is expected to grow with a compound (I) or a mixture according to the present invention, wherein the plant is transgenic or non-transgenic soybean.

According to the present invention, “increased yield” of a plant, in particular of an agricultural, silvicultural and/or ornamental plant, more preferably of an agricultural plant means that the yield of a product of the respective plant is increased by a measurable amount over the yield of the same product of the plant produced under the same conditions, but without the application of the composition of the invention.

According to the present invention, it is preferred that the yield be increased by at least 0.5%, more preferred at least 1%, even more preferred at least 2%, still more preferred at least 4%.

The improvement of the yield increase according to the present invention particularly means that the improvement of any one or several or all of the above mentioned plant characteristics are improved independently of the pesticidal action of the compound (I) or the mixture according to the present invention.

In another preferred embodiment, the present invention provides the use of the compound (I) or a mixture of the present invention for increasing the yield and/or improving the vigor of a plant, e.g. of an agricultural, silvicultural and/or ornamental plant, more preferably an agricultural plant.

The present invention further provides a method for increasing the yield and/or improving the vigor of a plant, preferably of an agricultural, silvicultural and/or ornamental plant, more preferably of an agricultural plant.

In a more preferred embodiment, the aforementioned method for increasing or improving the vigour of the plant comprises treating the plant and/or the locus where the plant is growing or is expected to grow with a compound (I) or a mixture according to the present invention, wherein the plant is preferably selected from the group consisting of field crops, such as potatoes, sugar beets, cereals such as wheat, rye, barley, oats, sorghum, rice, corn, cotton, rape, oilseed rape and canola, legumes such as soybeans, peas and field beans, sunflowers, sugar cane; ornamentals; or vegetables, such as cucumbers, tomatoes, or onions, leeks, lettuce, squashes, more preferably agricultural plants are potatoes, sugar beets, cereals such as wheat, rye, barley, oats, sorghum, rice, corn, cotton, soybeans, oilseed rape, canola, sunflower.

In a particular preferred embodiment, the afore-mentioned method for increasing the vigour of the plant treating the plant and/or the locus where the plant is growing or is expected to grow with a compound (I) or a mixture according to the present invention, wherein the plant is transgenic or non-transgenic soybean.

According to the present invention, “improved plant vigour” means that certain crop characteristics are increased or improved by a measurable or noticeable amount over the same factor of the plant produced under the same conditions, but without the application of the composition of the present invention.

Improved plant vigour can be characterized, among others, by at least one of the following improved properties of the plant:
improved vitality of the plant,
improved quality of the plant and/or of the plant products, e.g. enhanced protein content, enhanced fruit size, more uniform fruit or grain color etc.,
improved storability of harvested plant or plant parts,
improved visual appearance,
delay of senescence, thus, longer lasting photosynthetic active leaf apparatus,
enhanced root growth and/or more developed root system,
enhanced nodulation, in particular rhizobial nodulation,
longer panicles,
bigger pods,
improved pod set,
improved seed set,
improved fruit set,
reduced flower abortion,
reduced pod abortion,
reduced seed abortion,
bigger leaf blade,
less dead basal leaves,
improved leaf area index,
increased or improved plant stand density,
less plant verse (lodging),
increased plant weight,
increased plant height,
increased shoot growth
tillering increase,
increase in branching
stronger and/or more productive tillers or branches,
less non-productive tillers,
enhanced photosynthetic activity and/or enhanced pigment content and thus greener leaf color,
reduced production of ethylene and/or the inhibition of its reception by the plant,
earlier and improved germination
improved emergence,
earlier flowering,
earlier fruiting,
earlier grain maturity,
more uniform ripening,
less fertilizers needed,
improved harvest index,
improved shelf life,
increased water-use efficiency
increase in green leaf area
better harvestability.

The improvement of the plant vigour according to the present invention particularly means that the improvement of any one or several or all of the above mentioned plant characteristics are improved independently of the pesticidal action of the compound (I) or a mixture according to the present invention.

In a more preferred embodiment of the invention, the compound (I) or a mixture of the present invention is used for improving the vitality of the plant.

In a more preferred embodiment of the invention, the compound (I) or a mixture of the present invention is used for increasing the water-use efficiency of the plant.

In another preferred embodiment of the invention, the compound (I) or a mixture of the present invention is used for improveing the quality of the plant and/or of the plant products, e.g. enhanced protein content.

In another preferred embodiment of the invention, the compound (I) or a mixture of the present invention is used for improved storability of harvested plants or plant parts.

In another preferred embodiment of the invention, the compound (I) or a mixture of the present invention is used for delayed senescence and consequently longer photosynthetic activity of the leaf apparatus.

In another more preferred embodiment of the invention, the compound (I) or a mixture of the present invention is used for enhancing root growth and/or inducing the formation of a more developed root system of a plant.

In another preferred embodiment of the invention, the compound (I) or a mixture of the present invention is used for improved seed or fruit set.

In another preferred embodiment of the invention, the compound (I) or a mixture of the present invention is used for reduced flower abortion and/or pod abortion and/or seed abortion.

In another preferred embodiment of the invention, the compound (I) or a mixture of the present invention is used for bigger leaf blades.

In another preferred embodiment of the invention, the compound (I) or a mixture of the present invention is used for less dead basal leaves.

In another preferred embodiment of the invention, the compound (I) or a mixture of the present invention is used for reduced plant verse (lodging).

In another preferred embodiment of the invention, the compound of formula I or a mixture of the present invention is used for increased plant weight.

In another preferred embodiment of the invention, the compound (I) or a mixture of the present invention is used for increased plant height.

In another preferred embodiment of the invention, the compound (I) or a mixture of the present invention is used for stronger and/or more productive tillers or branches.

In another preferred embodiment of the invention, the compound (I) or a mixture of the present invention is used for enhanced photosynthetic activity and/or enhanced pigment content and thus greener leaf colour.

In another preferred embodiment of the invention, the compound (I) or a mixture of the present invention is used for improved emergence.

In another preferred embodiment of the invention, the compound (I) or a mixture of the present invention is used for increased shoot growth. In another preferred embodiment of the invention, the compound (I) or a mixture of the present invention is used for reduction of ethylene production and/or inhibition of ethylene reception by the plant.

In another preferred embodiment of the invention, the compound (I) or a mixture of the present invention is used for more uniform ripening of the plant, plant parts or fruits.

In another preferred embodiment of the invention, the compound (I) or a mixture of the present invention is used for improved harvestability.

In a most preferred embodiment of the invention, the compound (I) or a mixture of the present invention is used for enhancing improved vitality of the plant.

In another most preferred embodiment of the invention, the compound (I) or a mixture of the present invention is used for delayed senescence and consequently longer photosynthetic activity of the leaf apparatus.

In another most preferred embodiment of the invention, the compound (I) or a mixture of the present invention is used for bigger leaf blades.

In another most preferred embodiment of the invention, the compound (I) or a mixture of the present invention is used for less dead basal leaves.

In another most preferred embodiment of the invention, the compound (I) or a mixture of the present invention is used for improved seed or fruit set.

In another most preferred embodiment of the invention, the compound (I) or a mixture of the present invention is used for increased plant weight.

In another most preferred embodiment of the invention, the compound (I) or a mixture of the present invention is used for increased plant height.

In another most preferred embodiment of the invention, the compound (I) or a mixture of the present invention is used for increased shoot growth.

In yet another preferred embodiment, the present invention provides the use of the compound (I) or a mixture of the present invention for enhancing the plant's tolerance or resistance to abiotic stress factors.

The present invention further provides a method for enhancing a plant's tolerance or resistance to abiotic stress factors, which comprises treating the plant and/or the locus where the plant is growing or is expected to grow with a compound (I) or a mixture according to the present invention.

In a more preferred embodiment, the aforementioned method for enhancing a plant's tolerance or resistance to abiotic stress factors comprises treating the plant and/or the locus where the plant is growing or is expected to grow with a compound (I) or a mixture according to the present invention, wherein the plant is preferably selected from the group consisting of field crops, such as potatoes, sugar beets, cereals such as wheat, rye, barley, oats, sorghum, rice, corn, cotton, soybeans, rape, oilseed rape and canola, legumes such as soybeans, peas and field beans, sunflowers, sugar cane; ornamentals; or vegetables, such as cucumbers, tomatoes, or onions, leeks, lettuce, squashes, more preferably agricultural plants are potatoes, sugar beets, cereals such as wheat, rye, barley, oats, sorghum, rice, corn, cotton, soybeans, oilseed rape, canola, sunflower.

In a particular preferred embodiment, the afore-mentioned method for enhancing a plant's tolerance or resistance to abiotic stress factors treating the plant, the locus where the plant is growing or is expected to grow with a compound (I) or a mixture according to the present invention, wherein the plant is transgenic or non-transgenic soybean.

Abiotic stress factors have been defined above.

According to the present invention, “enhanced tolerance or resistance of a plant to abiotic stress factors” means (1.) that certain negative factors caused by abiotic stress are diminished in a measurable or noticeable amount as compared to plants exposed to the same conditions, but without being treated with the and (2.) that the negative effects are not diminished by a direct action of the composition on the stress factors, e.g. by its fungicidal or insecticidal action which directly destroys the microorganisms or pests, but rather by a stimulation of the plants' own defensive reactions against said stress factors.

Negative factors caused by abiotic stress are also well-known and can often be observed as reduced plant vigor (see above), e.g. dotted leaves, “burned leaves”, reduced growth, less flowers, less biomass, less crop yields, reduced nutritional value of the crops, later crop maturity, to give just a few examples.

In preferred embodiment, the tolerance of and/or resistance against abiotic stress factors is enhanced. Thus, according to a further embodiment of the present invention, the inventive compositions are used for stimulating the plant's own defensive reactions against abiotic stress such as extremes in temperature, e.g. heat or cold or strong variations in temperature or temperatures unusual for the specific season, drought, extreme wetness, high salinity, radiation (e.g. increased UV radiation due to the decreasing ozone protective layer), increased ozone levels, organic pollution (e.g. by phythotoxic amounts of pesticides) and/or inorganic pollution (e.g. by heavy metal contaminants).

In a more preferred embodiment, the compound (I) or a mixture according to the present invention is used for stimulating a plant's own defensive reactions against abiotic stress, where the abiotic stress factors are preferably selected from extremes in temperature, drought and extreme wetness.

In a more preferred embodiment, the compound (I) or a mixture according to the present invention is used for stimulating a plant's own defensive reactions against abiotic stress, where the abiotic stress factor is drought stress.

In another more preferred embodiment, the compound (I) or a mixture according to the present invention is used for reducing or inhibiting the injury caused to plants by phythotoxic amounts of pesticides such as fungicides, herbicides and/or insecticides.

During the present invention, it has been found that certain mixtures selected from the mixtures according to the present invention as described above, have not yet been explicitly described in the prior art—these mixtures however, have not only synergistic plant health effects as described hereinabove, but also provide synergistic fungicidal effects.

Thus, we also found a method for controlling pythopathogenic fungi, wherein the fungi, their habitat, breeding grounds, their locus or the plants to be protected against fungal attack, the soil or seed are treated with a pesticidally effective amount of these mixtures.

In one embodiment of the invention, the fungicidal mixtures for controlling pythopathogenic fungi are applied to seed, in an amount of from 0.001 g to 1 kg per 100 kg of seeds.

“Locus” means a plant, seed, soil, area, material or environment in which a pest is growing or may grow.

In general, “pesticidally effective amount” means the amount of the inventive mixtures or of compositions comprising the mixtures needed to achieve an observable effect on growth, including the effects of necrosis, death, retardation, prevention, and removal, destruction, or otherwise diminishing the occurrence and activity of the target organism. The pesticidally effective amount can vary for the various mixtures/compositions used in the invention. A pesticidally effective amount of the mixtures/compositions will also vary according to the prevailing conditions such as desired pesticidal effect and duration, weather, target species, locus, mode of application, and the like.

These mixtures comprise

(1) an amide of formula I (compound I); and

(2) a further fungicide II (compound II) selected from the group consisting of
(ii) carboxylic amides, selected from boscalid, fenhexamid, metalaxyl, fluopicolide (picobenzamid), zoxamide, mandipropamid and carpropamid
(iii) azoles, selected from cyproconazole (A1), epoxiconazole (A3), flusilazole (A4), ipconazole (A7), propiconazole (A9), prothioconazole (A10), tebuconazole (A11), cyazofamid (A12) and triazoxide (A15)
(iv) heterocyclic compounds, selected from fluazinam, cyprodinil, acibenzolar-S-methyl, proquinazid, quinoxyfen, fenpicionil, captan, folpet and fenpropidin,
(v) carbamates and dithiocarbamates, selected from iprovalicarb, maneb, propineb and flubenthiavalicarb (benthiavalicarb);
(vi) organo-chloro compounds such as flusulfamid;
(vii) inorganic active ingredients such as sulfur; and
(viii) various, selected from spiroxamine, cymoxanil, cyflufenamid and valiphenal.

In another embodiment of the invention, Tthese mixtures comprise
(1) an amide of formula I (compound I); and
(2) a further fungicide II (compound II) selected from the group consisting of
   (ii) carboxylic amides, selected from boscalid, fenhexamid, metalaxyl, fluopicolide (picobenzamid), zoxamide, mandipropamid and carpropamid
   (iii) azoles, selected from cyproconazole (A1), epoxiconazole (A3), flusilazole (A4), ipconazole (A7), propiconazole (A9), prothioconazole (A10), tebuconazole (A11), cyazofamid (A12) and triazoxide (A15)
   (iv) heterocyclic compounds, selected from fluazinam, cyprodinil, acibenzolar-S-methyl, proquinazid, quinoxyfen, fenpiclonil, captan, folpet and fenpropidin,
   (v) carbamates and dithiocarbamates, selected from iprovalicarb, maneb, propineb and flubenthiavalicarb (benthiavalicarb);
   (vi) organo-chloro compounds such as flusulfamid;
   (vii) inorganic active ingredients such as sulfur; and
   (viii) various, selected from spiroxamine, cymoxanil, cyflufenamid and valiphenal, and
(3) optionally a herbicide (compound IV) selected from glyphosate, sulfonisate and glyphosinate.

This subset of mixtures is herein below defined as “novel mixtures according to the present invention”. Naturally this subset is comprised by the mixtures according to the present invention. Thus, this term is mentioned only, if this subset needs to be addressed separately.

The weight ratio of the compound (I) to compound (II) or (IV) is preferably from 200:1 to 1:200, more preferably from 100:1 to 1:100, more preferably from 50:1 to 1:50 and in particular from 20:1 to 1:20. The utmost preferred ratio is 1:10 to 10:1. The weight ratio refers to the total weight of compounds (I) and compounds (II) in the mixture.

With respect to their intended use, the following secondary mixtures of compound (I) and compound (II) or (IV) listed in the table 3 below are especially preferred.

TABLE 3

| No. | (I) | (II) or (IV) |
|---|---|---|
| O-1 | Ia | boscalid |
| O-2 | Ia | fenhexamid |
| O-3 | Ia | fluopicolide |
| O-4 | Ia | zoxamide |
| O-5 | Ia | mandipropamid |
| O-6 | Ia | carpropamid |
| O-7 | Ia | cyazofamid, |
| O-8 | Ia | flusilazole |
| O-9 | Ia | ipconazole |
| O-10 | Ia | triazoxide |
| O-11 | Ia | fluazinam, |
| O-12 | Ia | cyprodinil |
| O-13 | Ia | acibenzolar-S-methyl |
| O-14 | Ia | proquinazid |
| O-15 | Ia | quinoxyfen |
| O-16 | Ia | fenpiclonil |
| O-17 | Ia | captan |
| O-18 | Ia | fenpropidin |
| O-19 | Ia | iprovalicarb |
| O-20 | Ia | maneb |
| O-21 | Ia | propineb |
| O-22 | Ia | flubenthiavalicarb |
| O-23 | Ia | flusulfamid |
| O-24 | Ia | sulfur |
| O-25 | Ia | spiroxamine |
| O-26 | Ia | cymoxanil |
| O-27 | Ia | cyflufenamid |
| O-28 | Ia | valiphenal |
| O-29 | Ia | metalaxyl |
| O-30 | Ia | tebuconazole |
| O-31 | Ia | cyproconazole |
| O-32 | Ia | epoxiconazole |
| O-33 | Ia | propiconazole |
| O-34 | Ia | prothioconazole |
| O-35 | Ib | boscalid |
| O-36 | Ib | fenhexamid |
| O-37 | Ib | fluopicolide |
| O-38 | Ib | zoxamide |
| O-39 | Ib | mandipropamid |
| O-40 | Ib | carpropamid |
| O-41 | Ib | cyazofamid, |
| O-42 | Ib | flusilazole |
| O-43 | Ib | ipconazole |
| O-44 | Ib | triazoxide |
| O-45 | Ib | fluazinam, |
| O-46 | Ib | cyprodinil |
| O-47 | Ib | acibenzolar-S-methyl |
| O-48 | Ib | proquinazid |
| O-49 | Ib | quinoxyfen |
| O-50 | Ib | fenpiclonil |
| O-51 | Ib | captan |
| O-52 | Ib | fenpropidin |
| O-53 | Ib | iprovalicarb |
| O-54 | Ib | maneb |
| O-55 | Ib | propineb |
| O-56 | Ib | flubenthiavalicarb |
| O-57 | Ib | flusulfamid |
| O-58 | Ib | sulfur |
| O-59 | Ib | spiroxamine |
| O-60 | Ib | cymoxanil |
| O-61 | Ib | cyflufenamid |
| O-62 | Ib | valiphenal |
| O-63 | Ib | metalaxyl |
| O-64 | Ib | tebuconazole |
| O-65 | Ib | cyproconazole |
| O-66 | Ib | epoxiconazole |
| O-67 | Ib | propiconazole |
| O-68 | Ib | prothioconazole |
| O-69 | Ic | boscalid |
| O-70 | Ic | fenhexamid |
| O-71 | Ic | fluopicolide |
| O-72 | Ic | zoxamide |
| O-73 | Ic | mandipropamid |
| O-74 | Ic | carpropamid |
| O-75 | Ic | cyazofamid, |
| O-76 | Ic | flusilazole |
| O-77 | Ic | ipconazole |
| O-78 | Ic | triazoxide |
| O-79 | Ic | fluazinam, |
| O-80 | Ic | cyprodinil |
| O-81 | Ic | acibenzolar-S-methyl |
| O-82 | Ic | proquinazid |
| O-83 | Ic | quinoxyfen |
| O-84 | Ic | fenpiclonil |
| O-85 | Ic | captan |
| O-86 | Ic | fenpropidin |
| O-87 | Ic | iprovalicarb |
| O-88 | Ic | maneb |
| O-89 | Ic | propineb |
| O-90 | Ic | flubenthiavalicarb |
| O-91 | Ic | flusulfamid |
| O-92 | Ic | sulfur |
| O-93 | Ic | spiroxamine |
| O-94 | Ic | cymoxanil |
| O-95 | Ic | cyflufenamid |
| O-96 | Ic | valiphenal |
| O-97 | Ic | metalaxyl |
| O-98 | Ic | tebuconazole |
| O-99 | Ic | cyproconazole |
| O-100 | Ic | epoxiconazole |
| O-101 | Ic | propiconazole |
| O-102 | Ic | prothioconazole |
| O-103 | Id | boscalid |
| O-104 | Id | fenhexamid |
| O-105 | Id | fluopicolide |
| O-106 | Id | zoxamide |
| O-107 | Id | mandipropamid |
| O-108 | Id | carpropamid |
| O-109 | Id | cyazofamid, |
| O-110 | Id | flusilazole |
| O-111 | Id | ipconazole |
| O-112 | Id | triazoxide |
| O-113 | Id | fluazinam, |
| O-114 | Id | cyprodinil |
| O-115 | Id | acibenzolar-S-methyl |
| O-116 | Id | proquinazid |
| O-117 | Id | quinoxyfen |
| O-118 | Id | fenpiclonil |
| O-119 | Id | captan |
| O-120 | Id | fenpropidin |
| O-121 | Id | iprovalicarb |
| O-122 | Id | maneb |
| O-123 | Id | propineb |
| O-124 | Id | flubenthiavalicarb |
| O-125 | Id | flusulfamid |
| O-126 | Id | sulfur |
| O-127 | Id | spiroxamine |
| O-128 | Id | cymoxanil |
| O-129 | Id | cyflufenamid |
| O-130 | Id | valiphenal |
| O-131 | Id | metalaxyl |
| O-132 | Id | tebuconazole |
| O-133 | Id | cyproconazole |
| O-134 | Id | epoxiconazole |
| O-135 | Id | propiconazole |
| O-136 | Id | prothioconazole |
| O-137 | Ie | boscalid |
| O-138 | Ie | fenhexamid |
| O-139 | Ie | fluopicolide |
| O-140 | Ie | zoxamide |
| O-141 | Ie | mandipropamid |
| O-142 | Ie | carpropamid |
| O-143 | Ie | cyazofamid, |
| O-144 | Ie | flusilazole |
| O-145 | Ie | ipconazole |
| O-146 | Ie | triazoxide |
| O-147 | Ie | fluazinam, |
| O-148 | Ie | cyprodinil |
| O-149 | Ie | acibenzolar-S-methyl |
| O-150 | Ie | proquinazid |
| O-151 | Ie | quinoxyfen |
| O-152 | Ie | fenpiclonil |
| O-153 | Ie | captan |
| O-154 | Ie | fenpropidin |
| O-155 | Ie | iprovalicarb |
| O-156 | Ie | maneb |
| O-157 | Ie | propineb |
| O-158 | Ie | flubenthiavalicarb |
| O-159 | Ie | flusulfamid |
| O-160 | Ie | sulfur |
| O-161 | Ie | spiroxamine |
| O-162 | Ie | cymoxanil |
| O-163 | Ie | cyflufenamid |
| O-164 | Ie | valiphenal |
| O-165 | Ie | metalaxyl |
| O-166 | Ie | tebuconazole |
| O-167 | Ie | cyproconazole |
| O-168 | Ie | epoxiconazole |
| O-169 | Ie | propiconazole |
| O-170 | Ie | prothioconazole |
| O-171 | If | boscalid |
| O-172 | If | fenhexamid |
| O-173 | If | fluopicolide |
| O-174 | If | zoxamide |
| O-175 | If | mandipropamid |
| O-176 | If | carpropamid |
| O-177 | If | cyazofamid, |
| O-178 | If | flusilazole |
| O-179 | If | ipconazole |
| O-180 | If | triazoxide |
| O-181 | If | fluazinam, |
| O-182 | If | cyprodinil |
| O-183 | If | acibenzolar-S-methyl |
| O-184 | If | proquinazid |
| O-185 | If | quinoxyfen |
| O-186 | If | fenpiclonil |
| O-187 | If | captan |
| O-188 | If | fenpropidin |
| O-189 | If | iprovalicarb |
| O-190 | If | maneb |
| O-191 | If | propineb |
| O-192 | If | flubenthiavalicarb |
| O-193 | If | flusulfamid |
| O-194 | If | sulfur |
| O-195 | If | spiroxamine |
| O-196 | If | cymoxanil |
| O-197 | If | cyflufenamid |
| O-198 | If | valiphenal |
| O-199 | If | metalaxyl |
| O-200 | If | tebuconazole |
| O-201 | If | cyproconazole |
| O-202 | If | epoxiconazole |
| O-203 | If | propiconazole |
| O-204 | If | prothioconazole |
| O-205 | Ig | boscalid |
| O-206 | Ig | fenhexamid |
| O-207 | Ig | fluopicolide |
| O-208 | Ig | zoxamide |
| O-209 | Ig | mandipropamid |
| O-210 | Ig | carpropamid |
| O-211 | Ig | cyazofamid, |
| O-212 | Ig | flusilazole |
| O-213 | Ig | ipconazole |
| O-214 | Ig | triazoxide |
| O-215 | Ig | fluazinam, |
| O-216 | Ig | cyprodinil |
| O-217 | Ig | acibenzolar-S-methyl |
| O-218 | Ig | proquinazid |
| O-219 | Ig | quinoxyfen |
| O-220 | Ig | fenpiclonil |
| O-221 | Ig | captan |
| O-222 | Ig | fenpropidin |
| O-223 | Ig | iprovalicarb |
| O-224 | Ig | maneb |
| O-225 | Ig | propineb |
| O-226 | Ig | flubenthiavalicarb |
| O-227 | Ig | flusulfamid |
| O-228 | Ig | sulfur |
| O-229 | Ig | spiroxamine |
| O-230 | Ig | cymoxanil |
| O-231 | Ig | cyflufenamid |
| O-232 | Ig | valiphenal |
| O-233 | Ig | metalaxyl |
| O-234 | Ig | tebuconazole |
| O-235 | Ig | cyproconazole |
| O-236 | Ig | epoxiconazole |
| O-237 | Ig | propiconazole |
| O-238 | Ig | prothioconazole |
| O-239 | Ia | glyphosate |
| O-240 | Ib | glyphosate |
| O-241 | Ic | glyphosate |
| O-242 | Id | glyphosate |
| O-243 | Ie | glyphosate |
| O-244 | If | glyphosate |
| O-245 | Ig | glyphosate |

Within the mixtures of table 3, the following mixtures are especially preferred:

O-1, O-2, O-3, O-4, O-5, O-6, O-7, O-8, O-9, O-10, O-11, O-12, O-13, O-14, O-15, O-16, O-17, O-18, O-19, O-20, O-21, O-22, O-23, O-24, O-25, O-26, O-27, O-28, O-29, O-30, O-31, O-32, O-33, O-34, O-69, O-70, O-71, O-72, O-73, O-74, O-75, O-76, O-77, O-78, O-79, O-80, O-81, O-82, O-83, O-84, O-85, O-86, O-87, O-88, O-89, O-90, O-91, O-92, O-93, O-94, O-95, O-96, O-97, O-98, O-99, O-100, O-101, O-102, O-103, O-104, O-105, O-106, O-107, O-108, O-109, O-110, O-111, O-112, O-113, O-114, O-115, O-116, O-117, O-118, O-119, O-120, O-121, O-122, O-123, O-124, O-125, O-126, O-127, O-128, O-129, O-130, O-131, O-132, O-133, O-134, O-135, O-136, O-137, O-138, O-139, O-140, O-141, O-142, O-143, O-144, O-145, O-146, O-147, O-148, O-149, O-150, O-151, O-152, O-153, O-154, O-155, O-156, O-157, O-158, O-159, O-160, O-161, O-162, O-163, O-164, O-165, O-166, O-167, O-168, O-169, O-170, O-171, O-172, O-173, O-174, O-175, O-176, O-177, O-178, O-179, O-180, O-181, O-182, O-183, O-184, O-185, O-186, O-187, O-188, O-189, O-190, O-191, O-192, O-193, O-194, O-195, O-196, O-197, O-198, O-199, O-200, O-201, O-202, O-203, O-204, O-205, O-206, O-207, O-208, O-209, O-210, O-211, O-212, O-213, O-214, O-215, O-216, O-217, O-218, O-219, O-220, O-221, O-222, O-223, O-224, O-225, O-226, O-227, O-228, O-239, O-241, O-244 and O-245.

Within this subset, the following mixtures are preferred:

O-1, O-2, O-3, O-4, O-5, O-6, O-7, O-8, O-9, O-10, O-11, O-12, O-13, O-14, O-15, O-16, O-17, O-18, O-19, O-20, O-21, O-22, O-23, O-24, O-25, O-26, O-27, O-28, O-29, O-30, O-31, O-32, O-33, O-34, O-69, O-70, O-71, O-72, O-73, O-74, O-75, O-76, O-77, O-78, O-79, O-80, O-81, O-82, O-83, O-84, O-85, O-86, O-87, O-88, O-89, O-90, O-91, O-92, O-93, O-94, O-95, O-96, O-97, O-98, O-99, O-100, O-101, O-102, O-171, O-172, O-173, O-174, O-175, O-176, O-177, O-178, O-179, O-180, O-181, O-182, O-183, O-184, O-185, O-186, O-187, O-188, O-189, O-190, O-191, O-192, O-193, O-194, O-195, O-196, O-197, O-198, O-199, O-200, O-201, O-202, O-203, O-204, O-205, O-206, O-207, O-208, O-209, O-210, O-211, O-212, O-213, O-214, O-215, O-216, O-217, O-218, O-219, O-220, O-221, O-222, O-223, O-224, O-225, O-226, O-227, O-228 and O-239, The following mixtures are even more preferred: O-1, O-2, O-3, O-4, O-5, O-6, O-7, O-8, O-9, O-10, O-11, O-12, O-13, O-14, O-15, O-16, O-17, O-18, O-19, O-20, O-21, O-22, O-23, O-24, O-25, O-26, O-27, O-28, O-29, O-30, O-31, O-32, O-33, O-34 O-239.

Herein, we have found that the simultaneous, that is joint or separate application of compound (I) and compound (II) or (IV) or successive application of compound (I) and compound (II) or (IV) allows enhanced control of pests, that means harmful plant diseases, compared to the control rates that are possible with the individual compounds (synergistic mixtures).

In addition, we have found that the simultaneous, that is joint or separate application of compound (I) and compound (II) or (III) and compound (IIb) or (IV) listed in the table 2 or the successive application of compound (I) and compound (II) or (III) and compound (IIb) or (IV) allows an enhanced control of pests, that means harmful plant diseases, compared to the control rates that are possible with the individual compounds (synergistic mixtures).

With respect to their intended use for controlling pest, the ternary mixtures of compound (I) and at least one compound selected from the group consisting of compounds (II), (IIb), (III) or (IV) listed in the table 2 above are especially preferred.

Within the ternary mixtures of table 2, the following mixtures are especially preferred with respect to their intended use for controlling pest:

N-1, N-2, N-3, N-4, N-5, N-6, N-7, N-8, N-9, N-10, N-11, N-12, N-13, N-14, N-15, N-16, N-17, N-18, N-19, N-20, N-21, N-22, N-23, N-24, N-25, N-26, N-27, N-28, N-29, N-30, N-31, N-32, N-33, N-34, N-35, N-36, N-37, N-38, N-39, N-40, N-41, N-42, N-43, N-44, N-45, N-46, N-47, N-48, N-49, N-50, N-51, N-52, N-53, N-54, N-55, N-56, N-57, N-58, N-59, N-60, N-61, N-62, N-63, N-64, N-65, N-66, N-67, N-68, N-69, N-70, N-71, N-72, N-73, N-74, N-75, N-76, N-77, N-78, N-79, N-80, N-81, N-82, N-83, N-84, N-85, N-86, N-87, N-88, N-89, N-90, N-91, N-92, N-93, N-94, N-95, N-96, N-97, N-98, N-100, N-101, N-102, N-103, N-104, N-105, N-106, N-107, N-108, N-109, N-110, N-111, N-112, N-113, N-114, N-115, N-116, N-117, N-118, N-119, N-120, N-121, N-122, N-123, N-124, N-125, N-126, N-127, N-128, N-129, N-130, N-131, N-132, N-133, N-134, N-135, N-960, N-961, N-962, N-963, N-964, N-965, N-966, N-967, N-968, N-969, N-970, N-971, N-972, N-973, N-974, N-1065, N-1066, N-1067, N-1068, N-1069, N-1070, N-1071, N-1072, N-1073, N-1083, N-1084, N-1085, N-1086, N-1087, N-1088, N-1089, N-1090, N-1091, N-1110, N-1111, N-1112, N-1113, N-1114, N-1115, N-1116, N-1117, N-1118, N-1119, N-1120, N-1121, N-1122, N-1123, N-1124, N-1125, N-1126 and N-1127.

Advantageously, the inventive mixtures are suitable for controlling the following plant diseases:

Albugo spp. (white rust) on ornamentals, vegetables (e. g. A. candida) and sunflowers (e. g. A. tragopogonis); Alternaria spp. (Alternaria leaf spot) on vegetables, rape (A. brassicola or brassicae), sugar beets (A. tenuis), fruits, rice, soybeans, potatoes (e. g. A. solani or A. alternata), tomatoes (e. g. A. solani or A. alternate) and wheat; Aphanomyces spp. on sugar beets and vegetables; Ascochyta spp. on cereals and vegetables, e. g. A. tritici (anthracnose) on wheat and A. hordei on barley; Bipolaris and Drechslera spp. (teleomorph: Cochliobolus spp.) on corn (e. g. D. maydis), cereals (e. g. B. sorokiniana: spot blotch), rice (e. g. B. oryzae) and turfs; Blumeria (formerly Erysiphe) graminis (powdery mildew) on cereals (e. g. on wheat or barley); Botrytis cinerea (teleomorph: Botryotinia fuckeliana: grey mold) on fruits and berries (e. g. strawberries), vegetables (e. g. lettuce, carrots, celery and cabbages), rape, flowers, vines, forestry plants and wheat; Bremia lactucae (downy mildew) on lettuce; Ceratocystis (syn. Ophiostoma) spp. (rot or wilt) on broad-leaved trees and evergreens, e. g. C. ulmi (Dutch elm disease) on elms; Cercospora spp. (Cercospora leaf spots) on corn, rice, sugar beets (e. g. C. beticola), sugar cane, vegetables, coffee, soybeans (e. g. C. sojina or C. kikuchii) and rice; Cladosporium spp. on tomatoes (e. g. C. fulvum: leaf mold) and cereals, e. g. C. herbarum (black ear) on wheat; Claviceps purpurea (ergot) on cereals; Cochliobolus (anamorph: Helminthosporium of Bipolaris) spp. (leaf spots) on corn (C. carbonum), cereals (e. g. C. sativus, anamorph: B. sorokiniana) and rice (e. g. C. miyabeanus, anamorph: H. oryzae); Colletotrichum (teleomorph: Glomerella) spp. (anthracnose) on cotton (e. g. C. gossypii), corn (e. g. C. graminicola), soft fruits, potatoes (e. g. C. coccodes: black dot), beans (e. g. C. lindemuthianum) and soybeans (e. g. C. truncatum or C. gloeosporioides); Corticium spp., e. g. C. sasakii (sheath blight) on rice; Corynespora cassiicola (leaf spots) on soybeans and ornamentals; Cycloconium spp., e. g. C. oleaginum on olive trees; Cylindrocarpon spp. (e. g. fruit tree canker or young vine decline, teleomorph: Nectria or Neonectria spp.) on fruit trees, vines (e. g. C. liriodendri, teleomorph: Neonectria liriodendri: Black Foot Disease) and ornamentals; Dematophora (teleomorph: Rosellinia) necatrix (root and stem rot) on soybeans; Diaporthe spp., e. g. D. phaseolorum (damping off) on soybeans; Drechslera (syn. Helminthosporium, teleomorph: Pyrenophora) spp. on corn, cereals, such as barley (e. g. D. teres, net blotch) and wheat (e. g. D. tritici-repentis: tan spot), rice and turf; Esca (dieback, apoplexy) on vines, caused by Formitiporia (syn. Phellinus) punctata, F. mediterranea, Phaeomoniella chlamydospora (earlier Phaeoacremonium chlamydosporum), Phaeoacremonium aleophilum and/or Bottyosphaeria obtusa; Elsinoe spp. on pome fruits (E. pyri), soft fruits (E. veneta: anthracnose) and vines (E. ampelina: anthracnose); Entyloma oryzae (leaf smut) on rice; Epicoccum spp. (black mold) on wheat; Erysiphe spp. (powdery mildew) on sugar beets (E. betae), vegetables (e. g. E. pisi), such as cucurbits (e. g. E. cichoracearum), cabbages, rape (e. g. E. cruciferarum); Eutypa lata (Eutypa canker or dieback, anamorph: Cytosporina lata, syn. Libertella blepharis) on fruit trees, vines and ornamental woods; Exserohllum (syn. Helminthosporium) spp. on corn (e. g. E. turcicum); Fusarium (teleomorph: Gibberella) spp. (wilt, root or stem rot) on various plants, such as F. graminearum or F. culmorum (root rot, scab or head blight) on cereals (e. g. wheat or barley), F. oxysporum on tomatoes, F. solani on soybeans and F. verticillioides on corn; Gaeumannomyces graminis (take-all) on cereals (e. g. wheat or barley) and corn; Gibberella spp. on cereals (e. g. G. zeae) and rice (e. g. G. fujikuroi: Bakanae disease); Glomerella cingulata on vines, pome fruits and other plants and G. gossypii on cotton; Grainstaining complex on rice; Guignardia bidwellii (black rot) on vines; Gymnosporangium spp. on rosaceous plants and junipers, e. g. G. sabinae (rust) on pears; Helminthosporium spp. (syn. Drechslera, teleomorph: Cochliobolus) on corn, cereals and rice; Hemileia spp., e. g. H. vastatrix (coffee leaf rust) on coffee; Isariopsis clavispora (syn. Cladosporium vitis) on vines; Macrophomina phaseolina (syn. phaseoli) (root and stem rot) on soybeans and cotton; Microdochium (syn. Fusarium) nivale (pink snow mold) on cereals (e. g. wheat or barley); Microsphaera diffusa (powdery mildew) on soybeans; Monilinia spp., e. g. M. laxa, M. fructicola and M. fructigena (bloom and twig blight, brown rot) on stone fruits and other rosaceous plants; Mycosphaerella spp. on cereals, bananas, soft fruits and ground nuts, such as e. g. M. graminicola (anamorph: Septoria tritici, Septoria blotch) on wheat or M. fijiensis (black Sigatoka disease) on bananas; Peronospora spp. (downy mildew) on cabbage (e. g. P. brassicae), rape (e. g. P. parasitica), onions (e. g. P. destructor), tobacco (P. tabacina) and soybeans (e. g. P. manshurica); Phakopsora pachyrhizi and P. meibomiae (soybean rust) on soybeans; Phialophora spp. e. g. on vines (e. g. P. tracheiphila and P. tetraspora) and soybeans (e. g. P. gregata: stem rot); Phoma lingam (root and stem rot) on rape and cabbage and P. betae (root rot, leaf spot and damping-off) on sugar beets; Phomopsis spp. on sunflowers, vines (e. g. P. viticola: can and leaf spot) and soybeans (e. g. stem rot: P. phaseoli, teleomorph: Diaporthe phaseolorum); Physoderma maydis (brown spots) on corn; Phytophthora spp. (wilt, root, leaf, fruit and stem root) on various plants, such as paprika and cucurbits (e. g. P. capsid), soybeans (e. g. P. megasperma, syn. P. sojae), potatoes and tomatoes (e. g. P. infestans: late blight) and broad-leaved trees (e. g. P. ramorum: sudden oak death); Plasmodiophora brassicae (club root) on cabbage, rape, radish and other plants; Plasmopara spp., e. g. P. viticola (grapevine downy mildew) on vines and P. halstedii on sunflowers; Podosphaera spp. (powdery mildew) on rosaceous plants, hop, pome and soft fruits, e. g. P. leucotricha on apples; Polymyxa spp., e. g. on cereals, such as barley and wheat (P. graminis) and sugar beets (P. betae) and thereby transmitted viral diseases; Pseudocercosporella herpotrichoides (eyespot, teleomorph: Tapesia yallundae) on cereals, e. g. wheat or barley; Pseudoperonospora (downy mildew) on various plants, e. g. P. cubensis on cucurbits or P. humili on hop; Pseudopezicula tracheiphila (red fire disease or ‘rotbrenner’, anamorph: Phialophora) on vines; Puccinia spp. (rusts) on various plants, e. g. P. triticina (brown or leaf rust), P. striiformis (stripe or yellow rust), P. hordei (dwarf rust), P. graminis (stem or black rust) or P. recondita (brown or leaf rust) on cereals, such as e. g. wheat, barley or rye, and asparagus (e. g. P. asparagi); Pyrenophora (anamorph: Drechslera) tritici-repentis (tan spot) on wheat or P. teres (net blotch) on barley; Pyricularia spp., e. g. P. oryzae (teleomorph: Magnaporthe grisea, rice blast) on rice and P. grisea on turf and cereals; Pythium spp. (damping-off) on turf, rice, corn, wheat, cotton, rape, sunflowers, soybeans, sugar beets, vegetables and various other plants (e. g. P. ultimum or P. aphanidermatum); Ramularia spp., e. g. R. collo-cygni (Ramularia leaf spots, Physiological leaf spots) on barley and R. beticola on sugar beets; Rhizoctonia spp. on cotton, rice, potatoes, turf, corn, rape, potatoes, sugar beets, vegetables and various other plants, e. g. R. solani (root and stem rot) on soybeans, R. solani (sheath blight) on rice or R. cerealis (Rhizoctonia spring blight) on wheat or barley; Rhizopus stolonifer (black mold, soft rot) on strawberries, carrots, cabbage, vines and tomatoes; Rhynchosporium secalis (scald) on barley, rye and triticale; Sarocladium oryzae and S. attenuatum (sheath rot) on rice; Sclerotinia spp. (stem rot or white mold) on vegetables and field crops, such as rape, sunflowers (e. g. S. sclerotiorum) and soybeans (e. g. S. rolfsii or S. sclerotiorum); Septoria spp. on various plants, e. g. S. glycines (brown spot) on soybeans, S. tritici (Septoria blotch) on wheat and S. (syn. Stagonospora) nodorum (Stagonospora blotch) on cereals; Uncinula (syn. Erysiphe) necator (powdery mildew, anamorph: Oidium tuckeri) on vines; Setospaeria spp. (leaf blight) on corn (e. g. S. turcicum, syn. Helminthosporium turcicum) and turf; Sphacelotheca spp. (smut) on corn, (e. g. S. reiliana: head smut), sorghum and sugar cane; Sphaerotheca fuliginea (powdery mildew) on cucurbits; Spongospora subterranea (powdery scab) on potatoes and thereby transmitted viral diseases; Stagonospora spp. on cereals, e. g. S. nodorum (Stagonospora blotch, teleomorph: Leptosphaeria [syn. Phaeosphaeria] nodorum) on wheat; Synchytrium endobioticum on potatoes (potato wart disease); Taphrina spp., e. g. T. deformans (leaf curl disease) on peaches and T. pruni (plum pocket) on plums; Thielaviopsis spp. (black root rot) on tobacco, pome fruits, vegetables, soybeans and cotton, e. g. T. basicola (syn. Chalara elegans); Tilletia spp. (common bunt or stinking smut) on cereals, such as e. g. T. tritici (syn. T. caries, wheat bunt) and T. controversa (dwarf bunt) on wheat; Typhula incarnata (grey snow mold) on barley or wheat; Urocystis spp., e. g. U. occulta (stem smut) on rye; Uromyces spp. (rust) on vegetables, such as beans (e. g. U. appendiculatus, syn. U. phaseoli) and sugar beets (e. g. U. betae); Ustilago spp. (loose smut) on cereals (e. g. U. nuda and U. avaenae), corn (e. g. U. maydis: corn smut) and sugar cane; Venturia spp. (scab) on apples (e. g. V. inaequalis) and pears; and Verticillium spp. (wilt) on various plants, such as fruits and ornamentals, vines, soft fruits, vegetables and field crops, e. g. V. dahliae on strawberries, rape, potatoes and tomatoes.

The inventive mixturs are also suitable for controlling harmful fungi in the protection of materials (e. g. wood, paper, paint dispersions, fiber or fabrics) and in the protection of stored products. As to the protection of wood and construction materials, the particular attention is paid to the following harmful fungi: Ascomycetes such as Ophiostoma spp., Ceratocystis spp., Aureobasidium pullulans, Sclerophoma spp., Chaetomium spp., Humicola spp., Petriella spp., Trichurus spp.; Basidiomycetes such as Coniophora spp., Coriolus spp., Gloeophyllum spp., Lentinus spp., Pleurotus spp., Poria spp., Serpula spp. and Tyromyces spp., Deuteromycetes such as Aspergillus spp., Cladosporium spp., Penicillium spp., Trichorma spp., Alternaria spp., Paecilomyces spp. and Zygomycetes such as Mucor spp., and in addition in the protection of stored products the following yeast fungi are worthy of note: Candida spp. and Saccharomyces cerevisae.

They are particularly important for controlling a multitude of fungi on various cultivated plants, such as cereals, e. g. wheat, rye, barley, triticale, oats or rice; beet, e. g. sugar beet or fodder beet; fruits, such as pomes, stone fruits or soft fruits, e. g. apples, pears, plums, peaches, almonds, cherries, strawberries, raspberries, blackberries or gooseberries; leguminous plants, such as lentils, peas, alfalfa or soybeans; oil plants, such as rape, mustard, olives, sunflowers, coconut, cocoa beans, castor oil plants, oil palms, ground nuts or soybeans; cucurbits, such as squashes, cucumber or melons; fiber plants, such as cotton, flax, hemp or jute; citrus fruit, such as oranges, lemons, grape-fruits or mandarins; vegetables, such as spinach, lettuce, asparagus, cabbages, carrots, onions, tomatoes, potatoes, cucurbits or paprika; lauraceous plants, such as avocados, cinnamon or camphor; energy and raw material plants, such as corn, soybean, rape, sugar cane or oil palm; corn; tobacco; nuts; coffee; tea; bananas; vines (table grapes and grape juice grape vines); hop; turf; natural rubber plants or ornamental and forestry plants, such as flowers, shrubs, broad-leaved trees or evergreens, e. g. conifers; and on the plant propagation material, such as seeds, and the crop material of these plants.

Preferably, these mixtures are used for controlling a multitude of fungi on field crops, such as potatoes sugar beets, tobacco, cereals such as wheat, rye, barley, oats, sorghum, rice, corn, cotton, rape, canola, legumes such as soybeans, peas and field beans, sunflowers, coffee or sugar cane; fruits; vines; ornamentals; or vegetables, such as cucumbers, tomatoes, onions, leeks, lettuce, beans or squashes.

The treatment of a plant or its growth locus or its propagation material, such as a seed, with the compound of formula I or a mixture according to the present invention of the invention can be accomplished in several ways. The components (I) and (II or III) may be applied directly to the propagules, especially the seed, and/or to the soil in which the seed is to be planted or before planting or transplanting, or for example, at the time of planting along with the seed (for example in-furrow application).

The compound (I) or a mixture according to the present invention may also comprise a solvent or solid carrier and compound (I) and in case a mixture is used compound (II) or (III) (and/or their salts) can be converted into customary types of agrochemical formulations, e.g. solutions, emulsions, suspensions, dusts, powders, pastes and granules together or separately. The formulation type depends on the particular intended purpose; in each case, it should ensure a fine and uniform distribution of the compound according to the invention.

Examples for formulation types are suspensions (SC, OD, FS), pastes, pastilles, wettable powders or dusts (WP, SP, SS, WS, DP, DS) or granules (GR, FG, GG, MG), which can be water-soluble or wettable, as well as gel formulations for the treatment of plant propagation materials such as seeds (GF). Usually the formulation types (e.g. SC, OD, FS, WG, SG, WP, SP, SS, WS, GF) are employed diluted. Formulation types such as DP, DS, GR, FG, GG and MG are usually used undiluted.

The formulations are prepared in a known manner (cf. U.S. Pat. No. 3,060,084, EP-A 707 445 (for liquid concentrates), Browning: “Agglomeration”, Chemical Engineering, Dec. 4, 1967, 147-48, Perry's Chemical Engineer's Handbook, 4th Ed., McGraw-Hill, New York, 1963, S. 8-57 and ff. WO 91/13546, U.S. Pat. No. 4,172,714, U.S. Pat. No. 4,144,050, U.S. Pat. No. 3,920,442, U.S. Pat. No. 5,180,587, U.S. Pat. No. 5,232,701, U.S. Pat. No. 5,208,030, GB 2,095,558, U.S. Pat. No. 3,299,566, Klingman: Weed Control as a Science (J. Wiley & Sons, New York, 1961), Hance et al.: Weed Control Handbook (8th Ed., Blackwell Scientific, Oxford, 1989) and Mollet, H. and Grubemann, A.: Formulation technology (Wiley VCH Verlag, Weinheim, 2001).

The agrochemical formulations may also comprise auxiliaries which are customary in agrochemical formulations. The auxiliaries used depend on the particular application form and active substance, respectively.

Examples for suitable auxiliaries are solvents, solid carriers, dispersants or emulsifiers (such as further solubilizers, protective colloids, surfactants and adhesion agents), organic and anorganic thickeners, bactericides, anti-freezing agents, anti-foaming agents, if appropriate colorants and tackifiers or binders (e.g. for seed treatment formulations).

Suitable solvents are water, organic solvents such as mineral oil fractions of medium to high boiling point, such as kerosene or diesel oil, furthermore coal tar oils and oils of vegetable or animal origin, aliphatic, cyclic and aromatic hydrocarbons, e. g. toluene, xylene, paraffin, tetrahydronaphthalene, alkylated naphthalenes or their derivatives, alcohols such as methanol, ethanol, propanol, butanol and cyclohexanol, glycols, ketones such as cyclohexanone and gamma-butyrolactone, fatty acid dimethylamides, fatty acids and fatty acid esters and strongly polar solvents, e. g. amines such as N-methylpyrrolidone.

Solid carriers are mineral earths such as silicates, silica gels, talc, kaolins, limestone, lime, chalk, bole, loess, clays, dolomite, diatomaceous earth, calcium sulfate, magnesium sulfate, magnesium oxide, ground synthetic materials, fertilizers, such as, e. g., ammonium sulfate, ammonium phosphate, ammonium nitrate, ureas, and products of vegetable origin, such as cereal meal, tree bark meal, wood meal and nutshell meal, cellulose powders and other solid carriers.

Suitable surfactants (adjuvants, wtters, tackifiers, dispersants or emulsifiers) are alkali metal, alkaline earth metal and ammonium salts of aromatic sulfonic acids, such as ligninsoulfonic acid (Borresperse® types, Borregard, Norway) phenolsulfonic acid, naphthalenesulfonic acid (Morwet® types, Akzo Nobel, U.S.A.), dibutylnaphthalene-sulfonic acid (Nekal® types, BASF, Germany),and fatty acids, alkylsulfonates, alkylarylsulfonates, alkyl sulfates, laurylether sulfates, fatty alcohol sulfates, and sulfated hexa-, hepta- and octadecanolates, sulfated fatty alcohol glycol ethers, furthermore condensates of naphthalene or of naphthalenesulfonic acid with phenol and formaldehyde, polyoxy-ethylene octylphenyl ether, ethoxylated isooctylphenol, octylphenol, nonylphenol, alkyiphenyl polyglycol ethers, tributylphenyl polyglycol ether, tristearylphenyl polyglycol ether, alkylaryl polyether alcohols, alcohol and fatty alcohol/ethylene oxide condensates, ethoxylated castor oil, polyoxyethylene alkyl ethers, ethoxylated polyoxypropylene, lauryl alcohol polyglycol ether acetal, sorbitol esters, lignin-sulfite waste liquors and proteins, denatured proteins, polysaccharides (e. g. methylcellulose), hydrophobically modified starches, polyvinyl alcohols (Mowiol® types, Clariant, Switzerland), polycarboxylates (Sokolan® types, BASF, Germany), polyalkoxylates, polyvinylamines (Lupasol® types, BASF, Germany), polyvinylpyrrolidone and the copolymers therof.

Examples for thickeners (i.e. compounds that impart a modified flowability to formulations, i. e. high viscosity under static conditions and low viscosity during agitation) are polysaccharides and organic and anorganic clays such as Xanthan gum (Kelzan®, CP Kelco, U.S.A.), Rhodopol® 23 (Rhodia, France), Veegum® (R.T. Vanderbilt, U.S.A.) or Attaclay® (Engelhard Corp., NJ, USA).

Bactericides may be added for preservation and stabilization of the formulation. Examples for suitable bactericides are those based on dichlorophene and benzylalcohol hemi formal (Proxel® from ICI or Acticide® RS from Thor Chemie and Kathon® MK from Rohm & Haas) and isothiazolinone derivatives such as alkylisothiazolinones and benzisothiazolinones (Acticide® MBS from Thor Chemie).

Examples for suitable anti-freezing agents are ethylene glycol, propylene glycol, urea and glycerin.

Examples for anti-foaming agents are silicone emulsions (such as e. g. Silikon® SRE, Wacker, Germany or Rhodorsil®, Rhodia, France), long chain alcohols, fatty acids, salts of fatty acids, fluoroorganic compounds and mixtures thereof.

Suitable colorants are pigments of low water solubility and water-soluble dyes. Examples to be mentioned and the designations rhodamin B, C. I. pigment red 112, C. I. solvent red 1, pigment blue 15:4, pigment blue 15:3, pigment blue 15:2, pigment blue 15:1, pigment blue 80, pigment yellow 1, pigment yellow 13, pigment red 112, pigment red 48:2, pigment red 48:1, pigment red 57:1, pigment red 53:1, pigment orange 43, pigment orange 34, pigment orange 5, pigment green 36, pigment green 7, pigment white 6, pigment brown 25, basic violet 10, basic violet 49, acid red 51, acid red 52, acid red 14, acid blue 9, acid yellow 23, basic red 10, basic red 108.

Examples for tackifiers or binders are polyvinylpyrrolidons, polyvinylacetates, polyvinyl alcohols and cellulose ethers (Tylose®, Shin-Etsu, Japan).

Powders, materials for spreading and dusts can be prepared by mixing or concomitantly grinding the compounds I (and optionally compound II) and, if appropriate, further active substances, with at least one solid carrier.

Granules, e. g. coated granules, impregnated granules and homogeneous granules, can be prepared by binding the active substances to solid carriers. Examples of solid carriers are mineral earths such as silica gels, silicates, talc, kaolin, attaclay, limestone, lime, chalk, bole, loess, clay, dolomite, diatomaceous earth, calcium sulfate, magnesium sulfate, magnesium oxide, ground synthetic materials, fertilizers, such as, e. g., ammonium sulfate, ammonium phosphate, ammonium nitrate, ureas, and products of vegetable origin, such as cereal meal, tree bark meal, wood meal and nutshell meal, cellulose powders and other solid carriers.

Examples for formulation types are:

1. Composition Types for Dilution with Water

i) Water-Soluble Concentrates (SL, LS)

10 parts by weight of compound (I) and optionally at least one compound selected from the group consisting of compounds (II), (IIb), (III) and (IV) according to the invention are dissolved in 90 parts by weight of water or in a water-soluble solvent. As an alternative, wetting agents or other auxiliaries are added. The active substance dissolves upon dilution with water. In this way, a formulation having a content of 10% by weight of active substance is obtained.

ii) Dispersible Concentrates (DC)

20 parts by weight of compound (I) and optionally at least one compound selected from the group consisting of compounds (II), (IIb), (III) and (IV) according to the invention are dissolved in 70 parts by weight of cyclohexanone with addition of 10 parts by weight of a dispersant, e. g. polyvinylpyrrolidone. Dilution with water gives a dispersion. The active substance content is 20% by weight.

iii) Emulsifiable Concentrates (EC)

15 parts by weight of compound (I) and optionally at least one compound selected from the group consisting of compounds (II), (IIb), (III) and (IV) according to the invention are dissolved in 75 parts by weight of xylene with addition of calcium dodecylbenzenesulfonate and castor oil ethoxylate (in each case 5 parts by weight). Dilution with water gives an emulsion. The composition has an active substance content of 15% by weight.

iv) Emulsions (EW, EO, ES)

25 parts by weight of compound (I) and optionally at least one compound selected from the group consisting of compounds (II), (IIb), (III) and (IV) according to the invention are dissolved in 35 parts by weight of xylene with addition of calcium dodecylbenzenesulfonate and castor oil ethoxylate (in each case 5 parts by weight). This mixture is introduced into 30 parts by weight of water by means of an emulsifying machine (Ultraturrax) and made into a homogeneous emulsion. Dilution with water gives an emulsion. The composition has an active substance content of 25% by weight.

v) Suspensions (SC, OD, FS)

In an agitated ball mill, 20 parts by weight of compound (I) and optionally at least one compound selected from the group consisting of compounds (II), (IIb), (III) and (IV) according to the invention are comminuted with addition of 10 parts by weight of dispersants and wetting agents and 70 parts by weight of water or an organic solvent to give a fine active substance suspension. Dilution with water gives a stable suspension of the active substance. The active substance content in the composition is 20% by weight.

vi) Water-Dispersible Granules and Water-Soluble Granules (WG, SG)

50 parts by weight of compound (I) and optionally at least one compound selected from the group consisting of compounds (II), (IIb), (III) and (IV) according to the invention are ground finely with addition of 50 parts by weight of dispersants and wetting agents and prepared as water-dispersible or water-soluble granules by means of technical appliances (e.g. extrusion, spray tower, fluidized bed). Dilution with water gives a stable dispersion or solution of the active substance. The composition has an active substance content of 50% by weight.

vii) Water-Dispersible Powders and Water-Soluble Powders (WP, SP, SS, WS)

75 parts by weight of compound (I) and optionally at least one compound selected from the group consisting of compounds (II), (IIb), (III) and (IV) according to the invention are ground in a rotor-stator mill with addition of 25 parts by weight of dispersants, wetting agents and silica gel. Dilution with water gives a stable dispersion or solution of the active substance. The active substance content of the composition is 75% by weight.

viii) Gel (GF)

In an agitated ball mill, 20 parts by weight of compound (I) and optionally at least one compound selected from the group consisting of compounds (II), (IIb), (III) and (IV) according to the invention are comminuted with addition of 10 parts by weight of dispersants, 1 part by weight of a gelling agent wetters and 70 parts by weight of water or of an organic solvent to give a fine suspension of the active substance. Dilution with water gives a stable suspension of the active substance, whereby a composition with 20% (w/w) of active substance is obtained.

2. Composition Types to be Applied Undiluted

ix) Dustable Powders (DP, DS)

5 parts by weight of compound (I) and optionally at least one compound selected from the group consisting of compounds (II), (IIb), (III) and (IV) according to the invention are ground finely and mixed intimately with 95 parts by weight of finely divided kaolin. This gives a dustable composition having an active substance content of 5% by weight.

x) Granules (GR, FG, GG, MG)

0.5 parts by weight of compound (I) and optionally at least one compound selected from the group consisting of compounds (II), (IIb), (III) and (IV) according to the invention is ground finely and associated with 99.5 parts by weight of carriers. Current methods are extrusion, spray-drying or the fluidized bed. This gives granules to be applied undiluted having an active substance content of 0.5% by weight.

xi) ULV Solutions (UL)

10 parts by weight of compound (I) and optionally at least one compound selected from the group consisting of compounds (II), (IIb), (III) and (IV) according to the invention are dissolved in 90 parts by weight of an organic solvent, e. g. xylene. This gives a composition to be applied undiluted having an active substance content of 10% by weight.

The agrochemical formulations generally comprise between 0.01 and 95%, preferably between 0.1 and 90%, most preferably between 0.5 and 90%, by weight of active substance(s). The active substance(s) are employed in a purity of from 90% to 100%, preferably from 95% to 100% (according to NMR spectrum).

Compositions, which are especially useful for the purposes of treatment of plant propagation materials, particularly seeds seed treatment are e.g.:

A Soluble concentrates (SL, LS)

D Emulsions (EW, EO, ES)

E Suspensions (SC, OD, FS)

F Water-dispersible granules and water-soluble granules (WG, SG)

G Water-dispersible powders and water-soluble powders (WP, SP, WS)

H Gel-Formulations (GF)

I Dustable powders (DP, DS)

These compositions can be applied to plant propagation materials, particularly seeds, diluted or undiluted.

The compositions in question give, after two-to-tenfold dilution, active substance concentrations of from 0.01 to 60% by weight, preferably from 0.1 to 40% by weight, in the ready-to-use preparations. Application can be carried out before or during sowing. Methods for applying or treating agrochemical compounds and compositions thereof, respectively, on to plant propagation material, especially seeds, are known in the art, and include dressing, coating, pelleting, dusting and soaking application methods of the propagation material (and also in furrow treatment). In a preferred embodiment, the compounds or the compositions thereof, respectively, are applied on to the plant propagation material by a method such that germination is not induced, e. g. by seed dressing, pelleting, coating and dusting.

The compounds of formula I or the compounds mixtures of the present invention can be used as such or in the form of their compositions, e. g. in the form of directly sprayable solutions, powders, suspensions, dispersions, emulsions, oil dispersions, pastes, dustable products, materials for spreading, or granules, by means of spraying, atomizing, dusting, spreading, brushing, immersing or pouring. The application forms depend entirely on the intended purposes; it is intended to ensure in each case the finest possible distribution of the compounds of formula I or the compounds mixtures of the present invention.

Aqueous application forms can be prepared from emulsion concentrates, pastes or wettable powders (sprayable powders, oil dispersions) by adding water. To prepare emulsions, pastes or oil dispersions, the compounds of formula I or the compounds mixtures of the present invention, as such or dissolved in an oil or solvent, can be homogenized in water by means of a wetter, tackifier, dispersant or emulsifier. Alternatively, it is possible to prepare concentrates composed of active substance, wetter, tackifier, dispersant or emulsifier and, if appropriate, solvent or oil, and such concentrates are suitable for dilution with water.

The active substance concentrations in the ready-to-use preparations can be varied within relatively wide ranges. In general, they are from 0.0001 to 10%, preferably from 0.001 to 1% by weight of compounds of formula I or the compounds mixtures of the present invention.

The compounds (I) or the compound mixtures of the present invention may also be used successfully in the ultra-low-volume process (ULV), it being possible to apply compositions comprising over 95% by weight of active substance, or even to apply the active substance without additives.

In another embodiment, the inventive compositions are used for reducing or inhibiting the injury caused to plants by phythotoxic amounts of pesticides such as fungicides, herbicides and/or insecticides.

The compositions according to the present invention comprise a plant health effective amount of a compound (I) or a plant health effective amount of compound (I) and at least one compound selected from the group consisting of compounds (II), (IIb), (III) and (IV) wherein compound (I) and at least one compound selected from the group consisting of compounds (II), (IIb), (III) and (IV) provide synergistic plant health effects.

The compositions according to the present invention comprising the novel mixtures according to the present invention comprise a pesticidally effective amount of compound (I) and compound (II) (or III), wherein compound (I) and (II) provide synergistic pesticidal effects.

In the methods according to the invention, the application rates of the mixtures according to the invention are from 0.3 g/ha to 2000 g/ha, preferably 0.005 kg/ha to 2.0 kg/ha, more preferably from 20 to 1000 g/ha, in particular from 20 to 500 g/ha, depending on the type of compound and the desired effects.

Various types of oils, wetters, adjuvants, herbicides, bactericides, other fungicides and/or pesticides may be added to the active substance(s) or the compositions comprising them, if appropriate not until immediately prior to use (tank mix). These agents can be admixed with the compound I or the mixtures according to the invention according to the invention in a weight ratio of 1:100 to 100:1, preferably 1:10 to 10:1.

Adjuvants which can be used are in particular organic modified polysiloxanes such as Break Thru S 240®; alcohol alkoxylates such as Atplus 245®, Atplus MBA 1303®, Plurafac LF 300® and Lutensol ON 30®; EO/PO block polymers, e. g. Pluronic RPE 2035® and Genapol B®; alcohol ethoxylates such as Lutensol XP 80®; and dioctyl sulfosuccinate sodium such as Leophen RA®.

The compound (I) according to the invention or the mixtures according to the invention can, in the use form as fungicides, also be present together with other active substances, e.g. with herbicides, insecticides, growth regulators, fungicides or else with fertilizers or inoculants, as pre-mix or, if appropriate, not until immediately prior to use (tank mix).

If a mixture according to the present invention is used, the compounds (I) and optionally compounds (II), (IIb), (III) or (IV) can be used individually or already partially or completely mixed with one another to prepare the composition according to the invention. It is also possible for them to be packaged and used further as combination composition such as a kit of parts.

In one embodiment of the invention, the kits may include one or more, including all, components that may be used to prepare the composition e.g. in form of an agrochemical formulation. These kits may include compound I and/or an adjuvant component and/or a insecticide component and/or a growth regulator component and/or a herbicide and/or an inoculant. One or more of the components may already be combined together or pre-formulated. In those embodiments where more than two components are provided in a kit, the components may already be combined together and as such are packaged in a single container such as a vial, bottle, can, pouch, bag or canister. In other embodiments, two or more components of a kit may be packaged separately, i.e., not pre-formulated. As such, kits may include one or more separate containers such as vials, cans, bottles, pouches, bags or canisters, each container containing a separate component for an agrochemical composition. In both forms, a component of the kit may be applied separately from or together with the further components or as a component of a combination composition according to the invention for preparing the composition according to the invention.

The user applies the composition according to the invention usually from a predosage device, a knapsack sprayer, a spray tank or a spray plane. Here, the agrochemical composition is made up with water and/or buffer to the desired application concentration, it being possible, if appropriate, to add further auxiliaries, and the ready-to-use spray liquor or the agrochemical composition according to the invention is thus obtained. Usually, 50 to 500 liters of the ready-to-use spray liquor are applied per hectare of agricultural useful area, preferably 80 to 400 liters. According to one embodiment, individual components of the composition according to the invention such as parts of a kit or parts of a binary or ternary mixture may be mixed by the user himself in a spray tank and further auxiliaries may be added, if appropriate (tank mix).

The following examples are intended to illustrate the invention, but without imposing any limitation.

### EXAMPLES

### Example 1

Mitcherlich pots of known weight were filled with 5.5 kg of sandy dry soil (pH 6.8) and fertilized (P, K and Mg) to optimal growing conditions. The culture was spring wheat (cv. Passat); 12 plants per pot. The experiment was conducted with 6 replications in a vegetation hall. Experiments were carried out under semi controlled conditions at very low disease-pressure with insignificant infection rates, protected from any undesired rain or water impact. The water consumption of each pot was calculated on the basis of the recorded measurements of the weight of the pots prior to each irrigation event up to the defined set point.

Nitrogen fertilizer (totally 1.75 g N/pot) was added in equal amounts at 3 stages to allow optimal growth conditions throughout the life cycle. All plants/pots were grown at optimal water supply by watering 2-3 times a day to 60% of the water holding capacity of the soil.

Compound Ia (62.5 g/L, 2 L in 400 L water/ha) was applied at growth stage 39/49 (BBCH scale), which is an EC formulation of compound Ia. Control plants were not treated.

Plant Height, as an indicator of plant vigor, was measured after heading. At maturity of the plants the grain, as an indicator of yield, was harvested and uniformly dried to 5% moisture content. Straw yield, as an another indicator of plant yield, was also determined and the number of halms with ear per pot was counted at maturity. Number of grains per pot was counted after harvest. Thousand Grain Weight (TGW), as yet another indicator of plant yield, was calculated based on grain yield per pot and number of grains per pot.

TABLE 4

| | Plant | Number of | | Straw | Grain |
|---|---|---|---|---|---|
| Compound | height | halms with | TGW | yield | yield/pot |
| applied | (cm) | ear/pot | (g) | (g/pot) | (g/pot) |
| Control | 74.7 | 32.3 | 31.4 | 65.9 | 59.8 |
| (untreated) | | | | | |
| Compound Ia | 76.2 | 37.5 | 32.0 | 70.0 | 74.2 |
| | (+2%) | (+16%) | (+2%) | (+6%) | (+6%) |

The results in table 4 illustrate that compound Ia improves the tillering of the wheat crop. The promotion of plant shoot growth can also be seen in the increase in straw yield and plant height. Besides the number of grains that are formed per ear as well as the grain weight (TGW), the number of halms with ears is generally determining the final grain yield of a cereal crop. As can be seen in table 4, all measured parameters were increased by the application of compound la in the example given. Consequently, compound Ia clearly increases the health of a plant leading to an increased plant vigor and increase in yield.

### Example 2

Spring wheat (cv. Passat) was cultivated in Mitcherlich pots as described above in example 1. The experiment was conducted with 6 replications in a vegetation hall. Experiments were carried out under semi controlled conditions at very low disease-pressure with insignificant infection rates, protected from any undesired rain or water impact. The water consumption of each pot was calculated on the basis of the recorded measurements of the weight of the pots prior to each irrigation event up to the defined set point.

Nitrogen fertilizer (totally 1.75 g N/pot) was added in equal amounts at 3 stages to allow optimal growth conditions throughout the life cycle. All plants/pots were grown at optimal water supply by watering 2-3 times a day to 60% of the water holding capacity of the soil until growth stage 55 (BBCH). Then, pots were only watered to 60% of the maximum water holding capacity of the soil after clear water stress symptoms on the plants were visible to apply severe drought stress.

Compound Ia (62.5 g/l, 2 L in 400 L water/ha) was applied at growth stage 39/49 (BBCH scale), which is an EC formulation of compound Ia. Control plants were not treated.

After ripening of the plants, the grain was harvested and uniformly dried to 5% moisture content. Grain yield per pot, grain yield per ear, number of grains per ear and number of grains per pot were determined as indicators of plant vigor and plant yield. The relation of grain yield to straw added to the grain yield was used to calculate the harvest index.

TABLE 5

| | Harvest index | Single ear grain | Number of |
|---|---|---|---|
| Compound | (grain yield g/grain + | yield | grains per |
| applied | straw yield g) | (g/ear) | ear |
| Control | 0.41 | 1.27 | 48.3 |
| (untreated) | | | |
| Compound Ia | 0.42 | 1.31 | 49.9 |
| | (+3%) | (+3%) | (+3%) |

The results in table 5 illustrate that compound Ia improves the seed set in wheat plants, especially under drought stress like in the present example. More grains per ear are generated, which resulted in an increased yield per ear. As a result, compound Ia clearly increases the plant vigor as well as the yield even under severe abiotic stress conditions like drought stress. Consequently, compound Ia increases the overall plant health according to the present invention.

### Example 3

Spring wheat (cv. Passat) was cultivated in Mitcherlich pots as described above in example 1. The experiment was conducted with 6 replications in a vegetation hall. Experiments were carried out under semi controlled conditions at very low disease-pressure with insignificant infection rates, protected from any undesired rain or water impact. The water consumption of each pot was calculated on the basis of the recorded measurements of the weight of the pots prior to each irrigation event up to the defined set point. Pots without crop coverage were used to estimate the evaporation of the soil.

Nitrogen fertilizer (totally 1.75 g N/pot) was added in equal amounts at 3 stages to allow optimal growth conditions throughout the life cycle. All plants/pots were grown at optimal water supply by watering 2-3 times a day to 60% of the water holding capacity of the soil until growth stage 55 (BBCH). Then, pots were only watered to 30% of the maximum water holding capacity of the soil to apply moderate drought stress. Compound Ia (62.5 g/l, 2 L in 400 L water/ha) was applied at growth stage 39/49 (BBCH scale), which is an EC formulation of comound Ia. Control plants were not treated.

At maturity of the plants the grain was harvested and uniformly dried to 5% moisture content. Number of grains per pot was counted after harvest. Thousand Grain Weight (TGW), as an indicator of plant yield, was calculated based on grain yield per pot and number of grains per pot. Transpiration was calculated on the basis of the amount of water added to the respective pots and the estimated soil evaporation. Water use efficiency, as an indicator of drought stress tolerance of a plant, was calculated based on the respective transpiration per pot.

TABLE 6

| Compound | Transpiration | Water use efficiency | Thousand Grain |
|---|---|---|---|
| applied | (L water/pot) | (kg grain/L water) | Weight (g) |
| Control (un- | 27.6 | 1.96 | 29.8 |
| treated) | | | |
| Compound Ia | 26.5 | 2.02 | 31.2 |
| | (−4%) | (+3%) | (+4%) |

Compound Ia improved seed development in terms of grain weight. In the applied drought stress condition compound la lead to a reduction of transpiration of water. Conseqeuntly, compound Ia treated wheat plants used less water to produce the increase in grain yield and less water per kg of grain. In addition, the reduction of transpiration and the increase in water use effiency led to an increase in plant vigor. The improved water use efficiency shows the improved tolerance against abiotic stresses, especially drought stress, by the compound la and its beneficial effect on additional plant health effects such as plant vigor and yield according to the present invention.

### Example 4

Soybeans were grown in 2008 in two field trials at the BASF experimental station in Dinuba, 10181 Avenue 416, Calif., U.S.A. In one trial, the variety Pioneer 93-M-11 was planted at a seeding rate of 88 kg/ha. In a second trial, the variety Crow C300 42 was planted at the same seeding rate. Both trials were setup as randomized complete block design with 5 replications, each. Plot size was 42 m². Compound la was used as an EC formulation (62.5 g a.i./L) with a dose rate of 0.64 L per hectar (40 g a.i./ha). The formulation was applied in a total spray volume of 300 L/ha. Compound Ia was sprayed at growth stage 34/37 (BBCH) with a tractor mounted spray boom with VS11003 spray nozzles at 3 bar spray pressure.

No disease symptoms were visible at the application time and no symptoms were detected at later stages.

Green leaf area, as an indicator of plant vigor, was assessed in the second trial (variety Crow C300 42) when all pods had reached their final size by estimating the green leaf area in 10 randomly chosen plants per plot. At maturity the grain was harvested and the grain yield per plot, as an indicator of plant yield, was determined (kg/plot). Finally, the grain yield per hectare was calculated (dt/ha). Thousand Grain Weight (TGW) was determined in the second trial (Crow C300 42).

TABLE 7
Green leaf area, TGW, and grain yield in maize,
one trial, Dinuba, CA, 2008

| Compound applied | % Green leaf area | TGW (g) |
|---|---|---|
| Control | 84.0 | 167.5 |
| (untreated) | | |
| Compound Ia | 88.4 | 177.0 |
| (increase as % | (+5.2%) | (+5.7%) |
| of untreated) | | |

TABLE 8
Soybean grain yield in dt/ha, two field trials, Dinuba, CA, 2008

| | Soybean grain | Soybean grain | |
|---|---|---|---|
| | yield (Trial 1) | yield (Trial 2) | |
| Compound applied | Pioneer 93M11 | Crow C300 42 | Mean |
| Control | 40.7 | 63.0 | 51.9 |
| (untreated) | | | |
| Compound Ia | 45.5 | 67.1 | 56.3 |
| (increase as % | (+11.6%) | (+6.5%) | (+8.5%) |
| of untreated) | | | |

Compound Ia increased photosynthetic active green leaf area by more than 5% versus the untreated control. A higher proportion of photosynthetic active leaf area results in a higher grain yield, as was observed in the present example. Grain size and grain weight was improved by compound Ia, respectively, as indicated by the increase in compound Ia treated plants over the untreated control (table 7).

Finally, compound Ia improved the seed yield in soybeans as shown in table 8. The grain yield in soybeans was improved by the comound la treatment by 8.5% on an average of the two trials with one trial showing an increase of up to almost 12%.

As can be seen, the application of compound Ia clearly increases the health of a plant leading to an increase in plant vigor and yield.

### Example 5

Maize was grown in 2008 in a field trial at the BASF experimental station in Dinuba, 10181 Avenue 416, Calif., U.S.A. The variety Dekalb RX940 was planted at a seeding rate of 10 plants/m². Four rows per plot were planted with a row spacing of 0.75 m. The trial was setup as a randomized bloc design with 5 replications, each. Plot size was 43 m². Compound Ia was used as an EC formulation (62.5 g a.i./L) with a dose rate of 0.8 L per hectar (50 g a.i./ha). The formulation was applied in a total spray volume of 400 L/ha. Compound Ia was sprayed at a growth stage 51/55 (BBCH) with a tractor mounted spray boom with VS11003 spray nozzles at 3 bar spray pressure.

No disease symptoms were visible at the application time and no symptoms were detected at later stages.

Green leaf area, as an indicator of plant vigor, was assessed beginning of ripening by estimating the green leaf area in 10 randomly chosen plants per plot.

At maturity the grain was harvested and the grain yield per plot, as an indicator of plant yield, was determined (kg/plot). Finally, the grain yield per hectare, as an aditional indicator of plant yield, was calculated (dt/ha). Furthermore, the Thousand Grain Weight (TGW) was determined in the second trial (Crow C300 42).

TABLE 9
Green leaf area, TGW, and grain yield in maize,
one trial, Dinuba, CA, 2008

| Compound | | | |
|---|---|---|---|
| applied | % Green leaf area | TGW (g) | Grain yield (dt/ha) |
| Control | 43.0 | 306.9 | 148.1 |
| (untreated) | | | |
| Compound Ia | 49.0 | 317.0 | 154.7 |
| (increase as % | (+13.9%) | (+3.3%) | (+4.5%) |
| of untreated) | | | |

Compound Ia increased photosynthetic active green leaf area by almost 14% compared to the untreated control. Consequently, a higher proportion of the leaf area remains photosynthetic active. More storage compounds (i.e. carbohydrates) are synthesized which then are trans-located to the grains. Bigger and more grains per cob are formed. The increase in grain size is indicated by the increase in TGW shown in table 9. Consequently, the treatment with compound Ia leads to an increase in maize grain yield. In the present example, the plots treated with compound Ia showed an yield increase of 4.5% compared to the untreated plots. As can be seen, the application of compound Ia clearly increases the health of a plant.

### Example 6

Maize was grown in 2008 in a field trial at the BASF experimental station in Dinuba, 10181 Avenue 416, Calif., U.S.A. The variety Pioneer 34-N-45 was planted at a seeding rate of 35.000 plants/ha. The trial was setup as a randomized bloc design with 5 replications, each. Plot size was 43 m².

The maize plants were either untreted, treated with epoxiconazol (A3), with compound Ia, and with a mixture comprising compound Ia and epoxiconazol. Epoxiconazol was applied as the commercial formulation OPUS™ (125 g a.i./L, SC formulation) at a dose rate of 0.4 L/ha (50 g a.i./ha). Compound Ia was used as an EC formulation (62.5 g a.i./L) with a dose rate of 0.8 L per hectar (50 g a.i./ha). Epoxiconazol was applied together with compound Ia (as a mixture) using a co-formulation of both compounds (EC formulation, 62.5 g a.i./L each) with a product rate of 0.8 L/ha. The formulation was applied in a total spray volume of 300 L/ha. Compound Ia was sprayed at growth stage 51/55 (BBCH) with a tractor mounted spray boom with VS11003 spray nozzles at 3 bar spray pressure.

No disease symptoms were visible at the application time and no symptoms were detected at later stages.

At maturity the grain was harvested and the grain yield per plot, as an indicator of plant yield, was determined (kg/plot). Finally, the grain yield per hectare was calculated (dt/ha).

The efficacy was calculated as % increase of the grain yield (dt/ha) by each treatment compared to the untreated control.

The expected efficacies of the combinations of the active compounds were estimated using Colby's formula (Colby, S. R., Calculating synergistic and antagonistic responses of herbicide combinations, Weeds, 15, pp. 20-22, 1967) and compared with the observed efficacies.

E=x+y−x·y/100 Colby's formula:
E expected efficacy, expressed in % of the untreated control, when using the mixture of the active compounds A and B at the concentrations a and b
x efficacy, expressed in % of the untreated control, when using the active ingredient A at the concentration a
y efficacy, expressed in % of the untreated control, when using the active ingredient B at the concentration b

TABLE 10
TGW, observed and expected efficacy according to Colby's formula.

| | | | Grain | Ob- | | |
|---|---|---|---|---|---|---|
| | a.i. | Formu- | yield | served | Expected | Syner- |
| Compound | rate | lation | (dt/ | efficacy | efficacy | gism |
| applied | (g/ha) | type | ha) | (%) | (%) | (%) |
| 1. Control | | | 154.3 | | | |
| (untreated) | | | | | | |
| 2. Compound Ia | 50 | EC | 154.9 | 0.4 | | |
| 3. Epoxiconazol | 50 | SC | 155.8 | 0.9 | | |
| (A3) | | | | | | |
| 4. Epoxiconazol | 50 + | EC | 161.7 | 4.8 | 1.3 | 3.5 |
| (A3) + | 50 | | | | | |
| compound Ia | | | | | | |

The results demonstrate that the efficacy in the combination ratios of the active compounds shown in table 10 is higher than the expected efficacy calculated using Colby's formula. Consequently, the secondary mixture described in table 10 is a synergistic plant health increasing mixture according to the invention.

### Example 7

Soybeans were grown in 2008 at the CEDUP “Caetano Vieira da Costa” in Sao José do Cerrito, Santa Catarina, Brazil. The variety M-SOY 6001 RR was planted in 2007, 11 Nov., at a seeding rate of 300.000 plants per ha. Row spacing was 50 cm. The trial was setup as a randomized bloc design with 4 replications. Plot size was 12.5 m².

Fungicide treatments were applied at BBCH GS 70-79 (pods reached 15-20 mm of final lenght). The fungicides were used as formulations.

Compound Ia was applied as an EC formulation (62.5 g/L—EC) at 0.64 L/ha (40 g ai/ha). Epoxiconazol (A3) and pyraclostrobin (S8) were coformulated in an SC formulation (160 g/L of epoxiconazol+260 g/L of pyraclostrobin—SC) and sprayed at a dose rate of 0.25 I/ha (40 g a.i./ha epoxiconazol and 65 g a.i./ha pyraclostrobin. The adjuvant DASH HC was added to the spray tank with 0.3% (v/v).

Finally, compound Ia was applied in a mixture together with epoxiconazol and pyraclostrobin forming a ternary mixture according to the present invention, using a coformulation of all three compounds (50 g/L of compound Ia+50 g/L of epoxiconazol+81 g/L of pyraclostrobin—EC). This formulation was sprayed at a rate of 0.8 L/ha (40 g a.i./ha compound Ia+40 g a.i./ha epoxiconazol+65 g a.i./ha pyraclostrobin). The formulations were diluted in water. Total spray volume for foliar application was 150 L/ha.

The trial was conducted under low disease pressure. No differences could be observed between the chemical treatments.

Plots were harvested at maturity of the soybean crop and the yield (thousand grain weight) was determined (table 11). The efficacy in yield increase was calculated as % increase of the Thousand Grain Weight (TGW) by the treatments compared to the untreated control.

The expected efficacies of the combinations of the active compounds were estimated using Colby's formula as defined above and compared with the observed efficacies.

TABLE 11

| | | | | Ob- | | |
|---|---|---|---|---|---|---|
| | a.i. | Formu- | | served | Expected | Syner- |
| Compound | rate | lation | TGW | efficacy | efficacy | gism |
| applied | (g/ha) | type | (g) | (%) | (%) | (%) |
| 1. Control | | | 153 | | | |
| (untreated) | | | | | | |
| 2. Compound Ia | 40 | EC | 153 | 0 | | |
| 3. Epoxiconazol | 40 + | SC | 158 | 3.3 | | |
| (A3) + | 65 | | | | | |
| pyraclostrobin | | | | | | |
| (S8) | | | | | | |
| 4. Epoxiconazol | 40 + | EC | 165 | 7.8 | 3.3 | 4.5 |
| (A3) + | 65 + | | | | | |
| pyraclostrobin | 40 | | | | | |
| (S8) + | | | | | | |
| compound Ia | | | | | | |

*including adjuvant DASH HC 0.3% v/v

The results demonstrate that when applying a ternary mixture according to the invention, comprising epoxiconazol (A3), pyraclostrobin (S8) and the amide compound Ia, the yield not only increases but in addition, that the observed efficacy is higher than the expected efficacy calculated using Colby's formula. Consequently, the mixture described in table 11 is a synergistic plant health increasing mixture according to the invention.

1-19. (canceled)

20. A method for improving the plant health of at least one plant variety, which method comprises treating the plant and/or the locus where the plant is growing or is intended to grow with an amide having the formula I (compound I) 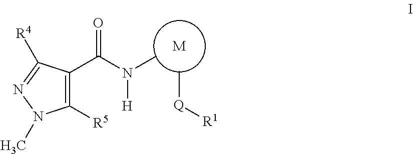
in which the substituents are as defined below:
R⁴ is methyl, difluoromethyl, or trifluoromethyl;
R⁵ is hydrogen or fluorine;
M is a thienyl ring or a phenyl ring, wherein the phenylring is substituted or not substituted with a fluorine atom;
Q is a direct bond, a cyclopropylene or an anellated bicyclo[2.2.1]heptane ring;
is cyclopropyl, 1,3-dimethylbutyl, isopropyl, phenyl substituted with two or three halogen atoms or a trifluoromethylthio radical.

21. The method as claimed in claim 20, wherein the amide of formula I (compound I) is selected from the group consisting of N-(3′,4′,5′-trifluorobiphenyl-2-yl)-3-difluoromethyl-1-methyl-1H-pyrazole-4-carboxamide, N-[2-(4′-trifluoromethylthio)-biphenyl]-3-difluoromethyl-1-methyl-1H-pyrazole-4-carboxamide, N-(3′,4′-dichloro-5-fluorobiphenyl-2-yl)-3-difluoromethyl-1-methylpyrazole-4-carboxamide (common name: bixafen), N-[2-(1,3-dimethylbutyl)-phenyl]-1,3-dimethyl-5-fluoro-1H-pyrazole-4-carboxamide, N-(2-bicyclopropyl-2-yl-phenyl)-3-difluoromethyl-1-methyl-1H-pyrazole-4-carboxamide (common name: sedaxane), N-[1,2,3,4-tetrahydro-9-(1-methylethyl)-1,4-methanonaphthalen-5-yl]-3-(difluoromethyl)-1-methyl-1H-pyrazole-4-carboxamide (common name: isopyrazam) and N-[2-(1,3-dimethylbutyl)-3-thienyl]-1-methyl-3-(trifluoromethyl)-1H-pyrazole-4-carboxamide (common name: penthiopyrad).

22. The method as claimed in claim 20, wherein the amide of formula I (compound I) is selected from the group consisting of N-(3′,4′,5′-trifluorobiphenyl-2-yl)-3-difluoromethyl-1-methyl-1H-pyrazole-4-carboxamide, N-(3′,4′-dichloro-5-fluorobiphenyl-2-yl)-3-difluoromethyl-1-methylpyrazole-4-carboxamide (common name: bixafen), N-[1,2,3,4-tetrahydro-9-(1-methylethyl)-1,4-methanonaphthalen-5-yl]-3-(difluoromethyl)-1-methyl-1H-pyrazole-4-carboxamide (common name: isopyrazam) and N-[2-(1,3-dimethylbutyl)-3-thienyl]-1-methyl-3-(trifluoromethyl)-1H-pyrazole-4-carboxamide (common name:
penthiopyrad).

23. The method as claimed in claim 22, wherein a mixture of the amide compound of formula I (compound I) and a further fungicide II (compound II) is applied in plant health synergistically effective amounts, wherein the further fungicide II is selected from the group consisting of
(i) a strobilurine selected from the group consisting of azoxystrobin, dimoxystrobin, fluoxastrobin, kresoxim-methyl, metominostrobin, orysastrobin, picoxystrobin, pyraclostrobin and trifloxystrobin;
(ii) a carboxylic amide selected from the group consisting of boscalid, fenhexamid, metalaxyl, dimethomorph, fluopicolide (picobenzamid), zoxamide, mandipropamid and carpropamid;
(iii) an azole selected from the group consisting of cyproconazole, difenoconazole, epoxiconazole, flusilazole, fluquinconazole, flutriafol, ipconazole, metconazole, propiconazole, prothioconazole, tebuconazole, cyazofamid, prochloraz, ethaboxam and triazoxide;
(iv) a heterocyclic compounds selected from the group consisting of famoxadone, fluazinam, cyprodinil, pyrimethanil, fenpropimorph, iprodione, acibenzolar-S-methyl, proquinazid, quinoxyfen, fenpiclonil, captan, fenpropidin, captafol and anilazin;
(v) a carbamate and dithiocarbamate selected from the group consisting of mancozeb, metiram, iprovalicarb, maneb, propineb, flubenthiavalicarb (benthiavalicarb) and propamocarb
(vi) an organo-chloro compound selected from the group consisting of thiophanate methyl, chlorothalonil, tolylfluanid and flusulfamid;
(vii) an inorganic active ingredient selected from the group consisting of Bordeaux composition, copper acetate, copper hydroxide, copper oxychloride, basic copper sulfate and sulfur;
(viii) an additional compound selected from the group consisting of spiroxamine, guazatin, cymoxanil, cyflufenamid, valiphenal, metrafenone, fosetly-aluminium and dithianon.

24. The method as claimed in claim 23, wherein the further fungicide II (compound II) is selected from the group consisting of
(i) a strobilurine selected from the group consisting of azoxystrobin, dimoxystrobin, orysastrobin, picoxystrobin, pyraclostrobin and trifloxystrobin;
(ii) a carboxcyclic amide selected from the group consisting of boscalid and dimethomorph
(iii) an azole selected from the group consisting of cyproconazole, difenoconazole, epoxiconazole, metconazole, propiconazole, prothioconazole and tebuconazole;
(iv) a heterocyclic compound selected from the group consisting of cyprodinil, pyrimethanil, fenpropimorph, iprodione, quinoxyfen and acibenzolar-S-methyl;
(v) a carbamate and dithiocarbamate selected from the group consisting of mancozeb, metiram, propineb and iprovalicarb;
(viii) an additional compound selected from the group consisting of dithianon and metrafenone.

25. The method as claimed in claim 23, wherein the further fungicide II (compound II) is selected from the group consisting of orysastrobin, pyraclostrobin, azoxystrobin and trifloxystrobin.

26. The method as claimed in claim 24, additionally comprising an insecticide (compound III), selected from fipronil and ethiprole.

27. The method as claimed in claim 24, additionally comprising a further fungicide III (compound IIb), selected from the group consisting of cyproconazole, difenoconazole, epoxiconazole, flusilazole, fluquinconazole, flutriafol, ipconazole, metconazole, propiconazole, prothioconazole, tebuconazole, cyazofamid, prochloraz, ethaboxam and triazoxide.

28. The method as claimed in claim 24, additionally comprising a herbicide (compound IV) selected from the group consisting of glyphosate, sulfosinate and glyphosinate.

29. The method as claimed in claim 20, wherein the plant is selected from the group consisting of agricultural plants, silvicultural plants and ornamental plants.

30. The method as claimed in claim 24, wherein the amide compound of the formula I (compound I) and at least one further compound selected from the group consisting of compounds (II), (IIb), (III) and (IV) are applied simultaneously, either as a mixture or separately, or subsequently to the plant and/or the locus where the plant is growing or intended to grow.

31. The method according to claim 24, wherein the amide compound of formula I (compound I) is applied to said plants and/or the locus in which they grow at an application rate of from about 0.005 kg/ha to about 2.0 kg/ha to said plants and/or the locus in which they grow.

32. A fungicidal mixture comprising in synergistically effective amounts
an amide having the formula I (compound I) 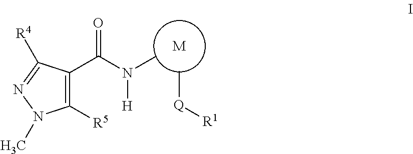
in which the substituents are as defined below:
R⁴ is methyl, difluoromethyl, or trifluoromethyl;
R⁵ is hydrogen or fluorine;
M is a thienyl ring or a phenyl ring, wherein the phenylring is substituted or not substituted with a fluorine atom;
Q is a direct bond, a cyclopropylene or an anellated bicyclo[2.2.1]heptane ring;
R¹ is cyclopropyl, 1,3-dimethylbutyl, isopropyl, phenyl substituted with two or three halogen atoms or a trifluoromethylthio radical; and
either a further fungicide II (compound II) selected from the group consisting of
(ii) a carboxylic amide selected from the group consisting of boscalid, fenhexamid, metalaxyl, fluopicolide (picobenzamid), zoxamide, mandipropamid and carpropamid;
(iii) an azole selected from the group consisting of cyproconazole, epoxiconazole, flusilazole, ipconazole, propiconazole, prothioconazole, tebuconazole, cyazofamid and triazoxide;
(iv) a heterocyclic compound selected from the group consisting of fluazinam, cyprodinil, acibenzolar-S-methyl, proquinazid, quinoxyfen, fenpiclonil, captan, folpet and fenpropidin;
(v) a carbamate and dithiocarbamate selected from the group consisting of iprovalicarb, maneb, propineb and flubenthiavalicarb (benthiavalicarb);
(vi) an organo-chloro compound;
(vii) an inorganic active ingredient; and
(viii) an additional compound selected from the group consisting of spiroxamine, cymoxanil, cyflufenamid and valiphenal;
or a herbicide (compound IV) selected from glyphosate, sulfosinate and glyposinate.
